(19) United States
(12) Patent Application Publication
(10) Pub. No.: US 2022/0245650 A1
(43) Pub. Date: Aug. 4, 2022

(54) Product Information Method and System Using a Product Passport for Providing Item-Specific Product Information

(71) Applicant: Bruce Macmillan, Twickenham (GB)

(72) Inventor: Bruce Macmillan, Twickenham (GB)

(21) Appl. No.: 17/727,718

(22) Filed: Apr. 23, 2022

Related U.S. Application Data
(63) Continuation-in-part of application No. 13/035,746, filed on Feb. 25, 2011.

(51) Int. Cl. G06Q 30/00; G06Q 30/06

(52) U.S. Cl. CPC G06Q 30/018; G06Q 2220/00; G06Q 30/0629; G06Q 30/0627

(57) ABSTRACT

A computer-implemented method of providing information about an individual product includes: using a product information server comprised in a product information system, deciding, by the product information system, using the product information server, an application by a system applicant applying to register as a system user of the product information system; creating, by the product information system, using the product information server, a product passport configured to provide item-specific product information regarding a unique individual product; populating the product passport, by the product information system, using the product information server, with item-specific product information regarding the product; receiving from a system user, by the product information system, using the product information server, a user request for item-specific product information regarding the product; providing, by the product information system, the item-specific product information to the system user; and recording, by the product information system, a product transaction involving the product.

### PRIORITY CLAIM

The present application is a continuation-in-part that claims the priority benefit of U.S. utility patent application Ser. No. 13/035,746, filed Feb. 25, 2011.

### FIELD OF THE INVENTION

The present disclosure relates generally to methods and systems for using a product passport for providing item-specific product information.

### BRIEF DESCRIPTION OF THE FIGURES

The figures depict various embodiments for purposes of illustration only. One skilled in the art will readily recognize from the following discussion that alternative embodiments of the structure and methods illustrated herein may be employed without departing from the principles described herein.

FIG. 1 is a block diagram of a product information system for using a product passport for providing item-specific product information.

FIG. 2 is a flow chart of a method for using a product passport and a product information system for providing item-specific product information.

FIG. 3 is a flow chart of a method for using a product passport and a product information system for providing item-specific product information.

FIG. 4 is a flow chart of a method for using a product passport and a product information system for providing item-specific product information.

FIG. 5 is a flow chart of a method for using a product passport and a product information system for providing item-specific product information.

FIG. 6 is a flow chart of a method for using a product passport and a product information system for providing item-specific product information.

FIG. 7 is a flow chart of a method for using a product passport and a product information system for providing item-specific product information.

FIG. 8 is a flow chart of a method for using a product passport and a product information system for providing item-specific product information.

FIG. 9 is a flow chart of a method for using a product passport and a product information system for providing item-specific product information.

The figures depict various embodiments for purposes of illustration only. One skilled in the art will readily recognize from the following discussion that alternative embodiments of the structure and methods illustrated herein may be employed without departing from the principles described herein.

### SUMMARY

A computer-implemented method of providing information about an individual product includes: using a product information server comprised in a product information system, deciding an application by a system applicant applying to register as a system user of the product information system; creating, using the product information server, a product passport configured to provide item-specific product information regarding a unique individual product; populating the product passport, using the product information server, with item-specific product information regarding the product; receiving from a system user, by the product information server, a user request for item-specific product information regarding the product; using the product information system, providing, by the product information server, the item-specific product information to the system user; and recording, by the product information system, using the product information server, a product transaction involving the product.

A product information system configured to do one or more of create a product passport, provide product information and verify product information regarding an individual product item includes: a product information server configured to gather product information, the product information server further configured to do one or more of create a product passport, provide product information and verify product information, the product passport comprising one or more of product passport information and an alphanumeric code unique to the product; a network usable by the product information server to gather the product information; a system-participant-server operable connection configured to operably connect a system participant to the product information server via the network, the system participant comprising one or more of a system user and a third-party information source configured to provide information regarding the product, the system user comprising one or more of a manufacturer configured to contribute to creation of a product, a transporter configured to change a location of a product, a retailer configured to offer a product for sale, an end user configured to do one or more of use and consume a product, and a disposer configured to dispose of a product, wherein at least two of the system participants are operably connected to each other; and a database configured to hold one or more of the product passport information and the product's unique alphanumeric code, the database operably connected to the product information server.

A computer-implemented method of providing information about an individual product item, using a product information system comprising a product information server includes: receiving, by the product information system, using the product information server, a passport request for a product passport from a manufacturer of the product, the passport request comprising product information regarding the product; creating a product passport for the product, by the product information system, using the product information server, the product passport comprising a unique alphanumeric code; sending, by the product information system, using the product information server, the product passport to the manufacturer; receiving a manufacturing code application update, by the product information system, using the product information server, the manufacturing code application update comprising an update advising the product information system that the manufacturer has applied the alphanumeric code to the product; provisionally associating the product passport with the product, by the product information system, using the product information server; receiving, by the product information system, using the product information server, further product information from a system user; validating, by the product information system, using the product information server, the received further product information; deciding, by the product information system, using the product information server, to accept the received further product information; obtaining, by the product information system, using the product information server, third-party product information regarding the product from a trusted third-party information source; generating, by the product information system, using the product information server, product comparison information usable to compare the product with a comparable product; overlaying, by the product information system, using the product information server, two or more of the product information, the third-party product information, and the product comparison information; validating the product, by the product information system, using the product information server; making, by the product information system, using the product information server, a product decision using the overlay; accepting the product, by the product information system, using the product information server; authenticating, by the product information system, using the product information server, the product as a legitimate, known product on the product information system; notifying the manufacturer, by the product information system, using the product information server, of acceptance of the product by the product information system; associating the product passport with the product, by the product information system, using the product information server; populating, by the product information system, using the product information server the product information into the product passport, thereby completing an initial product passport; and storing, by the product information system, using the product information server, the product passport.

A computer-implemented method of providing information about an individual product item, using a product information system comprising a product information server includes: receiving, by the product information system, using the product information server, a passport request for a product passport from a manufacturer of the product, the passport request comprising product information regarding the product; validating, by the product information system, using the product information server, the received product information; deciding, by the product information system, using the product information server, to accept the received product information; receiving, by the product information system, using the product information server, further product information regarding the product from the manufacturer; obtaining, by the product information system, using the product information server, third-party product information regarding the product from a trusted third-party information source; generating, by the product information system, using the product information server, product comparison information usable to compare the product with a comparable product; overlaying, by the product information system, using the product information server, two or more of the product information, the third-party product information, and the product comparison information; validating the product, by the product information system, using the product information server; making, by the product information system, using the product information server, a product decision using the overlay; accepting the product, by the product information system, using the product information server; authenticating, by the product information system, using the product information server, the product as a legitimate, known product on the product information system; notifying the manufacturer, by the product information system, using the product information server, of acceptance of the product by the product information system; creating, by the product information system, using the product information server, a product passport for the product, the product passport comprising a unique alphanumeric code; associating, by the product information system, using the product information server, the product passport with the product; sending the product passport, by the product information system, using the product information server, to the manufacturer; receiving a manufacturing code application update, by the product information system, using the product information server, the manufacturing code application update comprising an update advising the product information system that the manufacturer has applied the alphanumeric code to the product; populating, by the product information system, using the product information server, the product information into the product passport, thereby completing an initial product passport; and storing, by the product information system, using the product information server.

A computer-implemented method of providing information about an individual product item, using a product information system comprising a product information server includes: associating, by the product information system, using the product information server, with an individual product item at a time of its manufacture, a unique product passport comprising its own unique alphanumeric code; receiving, by the product information system, using the product information server, from a system user, a user request for item-specific product information regarding the product; extracting, by the product information system, using the product information server, from the product passport, the requested item-specific information; extracting, by the product information system, using the product information server, product-related information from a related product item product passport of a related product item; obtaining, by the product information server, from the product information system, user-requested product information; and presenting, by the product information system, using the product information server, the requested product information to the system user.

A computer-implemented method of providing information about an individual product item, using a product information system comprising a product information server includes: receiving, by the product information system, using the product information server, from a first system user, first system user information comprising first system user identifying information identifying the first system user, the first system user information further comprising first system user product relationship information regarding a relationship of the first system user to the product, the first system user information further comprising first system user transaction information identifying a desired transaction of the first system user with a product, the desired transaction intended to transfer the product from the first system user to a second system user, the first system user transaction information further comprising the product's unique alphanumeric code; recording, by the product information system, using the product information server, the relationship of the first system user to the product; recording, by the product information system, using the product information server, the first system user transaction information; receiving, by the product information system, using the product information server, from the second system user, second system user information comprising second system user identifying information identifying the second system user, the second system user information further comprising second system user product relationship information regarding a relationship of the second system user to the product, the second system user information further indicating that the second system user is completing the desired transaction, the second system user information further comprising the product's unique alphanumeric code; receiving, by the product information system, using the product information server, transaction information confirming completion of the desired transaction; validating, by the product information system, using the product information server, the received transaction information; recording by the product information system, using the product information server, a change of ownership of the product from the first system user to the second system user; and updating, by the product information system, using the product information server, a product possession record comprised in the product passport.

A computer-implemented method of providing information about an individual product item, using a product information system comprising a product information server includes: receiving, by the product information system, using the product information server, system applicant information from a system applicant applying to register as a system user of the product information system; validating, by the product information system, using the product information server, the received system applicant information; deciding, by the product information system, using the product information server, to accept the received system applicant information; obtaining, by the product information system, using the product information server, third-party system applicant information regarding the system applicant from a trusted third-party information source; generating, by the product information system, using the product information server, system applicant comparison information usable to compare the system applicant with a comparable system user; overlaying, by the product information system, using the product information server, two or more of the system applicant information, the third-party system applicant information, and the system applicant comparison information; validating the system applicant, by the product information system, using the product information server; making, by the product information system, using the product information server, a system applicant decision using the overlay; accepting the system applicant as a system user, by the product information system, using the product information server; authenticating, by the product information system, using the product information server, the system user as a legitimate, known user of the product information system; notifying the system applicant, by the product information system, using the product information server, of the acceptance of the system applicant as a system user; receiving, by the product information system, using the product information server, a passport request for a product passport from a manufacturer of the product, the passport request comprising product information regarding the product; creating a product passport for the product, by the product information system, using the product information server, the product passport comprising a unique alphanumeric code; sending, by the product information system, using the product information server, the product passport to the manufacturer; receiving a manufacturing code application update, by the product information system, using the product information server, the manufacturing code application update comprising an update advising the product information system that the manufacturer has applied the alphanumeric code to the product; provisionally associating the product passport with the product, by the product information system, using the product information server; receiving, by the product information system, using the product information server, further product information from a system user; validating, by the product information system, using the product information server, the received further product information; deciding, by the product information system, using the product information server, to accept the received further product information; obtaining, by the product information system, using the product information server, third-party product information regarding the product from a trusted third-party information source; generating, by the product information system, using the product information server, product comparison information usable to compare the product with a comparable product; overlaying, by the product information system, using the product information server, two or more of the product information, the third-party product information, and the product comparison information; validating the product, by the product information system, using the product information server; making, by the product information system, using the product information server, a product decision using the overlay; accepting the product, by the product information system, using the product information server; authenticating, by the product information system, using the product information server, the product as a legitimate, known product on the product information system; notifying the manufacturer, by the product information system, using the product information server, of acceptance of the product by the product information system; associating the product passport with the product, by the product information system, using the product information server; populating, by the product information system, using the product information server, the product information into the product passport, thereby completing an initial product passport; storing, by the product information system, using the product information server, the product passport; receiving, by the product information system, using the product information server, from a system user, a user request for item-specific product information regarding the product; extracting, by the product information system, using the product information server, from the product passport, the requested item-specific information; extracting, by the product information system, using the product information server, product-related information from a related product item product passport of a related product item; obtaining, by the product information server, from the product information system, user-requested product information; presenting, by the product information system, using the product information server, the requested product information to the system user; receiving, by the product information system, using the product information server, from a first system user, first system user information comprising first system user identifying information identifying the first system user, the first system user information further comprising first system user product relationship information regarding a relationship of the first system user to the product, the first system user information further comprising first system user transaction information identifying a desired transaction of the first system user with a product, the desired transaction intended to transfer the product from the first system user to a second system user, the first system user transaction information further comprising the product's unique alphanumeric code; recording, by the product information system, using the product information server, the relationship of the first system user to the product; recording, by the product information system, using the product information server, the first system user transaction information; receiving, by the product information system, using the product information server, from the second system user, second system user information comprising second system user identifying information identifying the second system user, the second system user information further comprising second system user product relationship information regarding a relationship of the second system user to the product, the second system user information further indicating that the second system user is completing the desired transaction, the second system user information further comprising the product's unique alphanumeric code; receiving, by the product information system, using the product information server, transaction information confirming completion of the desired transaction; validating, by the product information system, using the product information server, the received transaction information; recording by the product information system, using the product information server, a change of ownership of the product from the first system user to the second system user; and updating, by the product information system, using the product information server, a product possession record comprised in the product passport.

A computer-implemented method of providing information about an individual product item, using a product information system comprising a product information server includes: recording, by the product information system, using the product information server, an acceptance of a system applicant as a system user; recording, by the product information system, using the product information server, a passport request regarding a product from the system user; recording creation, by the product information system, using the product information server, of a product passport for the product, the product passport comprising a unique alphanumeric code; recording product manufacture information received from the manufacturer, by the product information system, using the product information server, regarding manufacturing of the product; recording, by the product information system, using the product information server, acceptance of the product by the product information system; recording, by the product information system, using the product information server, transaction information regarding a completed transaction changing one or more of the product ownership and the product location; and recording by the product information system, using the product information server, the change of one or more of the product ownership and the product location.

A computer-implemented method of providing information about an individual product item, using a product information system comprising a product information server includes: generating, by the product information system, using the product information server, a product passport for a unique individual product; hosting, by the product information system, using the product information server, the product passport on the product information system; converting, by the product information system, using the product information server, the product passport's unique alphanumeric code into a machine readable form; applying by the product information system, using the product information server, the product passport's unique alphanumeric code to the product to which it is being associated; receiving, by the product information system, using the product information server, from a manufacturer of the product, product manufacture information relating to manufacture of the product; associating, by the product information system, using the product information server, the product passport with the product; associating, by the product information system, using the product information server, the product manufacture information with the product passport; receiving, by the product information system, using the product information server, a request for the product passport from a registered system user within a supply chain of the product; and transmitting, by the product information system, using the product information server, the requested product passport alphanumeric code to the system user.

### DETAILED DESCRIPTION

While the present invention is susceptible of embodiment in many different forms, there is shown in the drawings and will herein be described in detail one or more specific embodiments, with the understanding that the present disclosure is to be considered as exemplary of the principles of the invention and not intended to limit the invention to the specific embodiments shown and described. In the following description and in the several figures of the drawings, like reference numerals are used to describe the same, similar or corresponding parts in the several views of the drawings.

Embodiments of the present invention relate to a method of associating with an individual product item at a time of its manufacture a unique product passport that comprises its own unique alphanumeric code that is hosted within a product information system. The alphanumeric code is unique to the individual product item, as opposed to the individual product type. That is, the alphanumeric code is unique and different for each product item, so that if ten televisions of the same exact model are produced, identical in all specifications, still each bears its own individual alphanumeric code, the alphanumeric code being different from that for each of the other nine televisions, even though they are all nominally “identical” with each other. Preferably, but not necessarily, the alphanumeric code comprises a non-sequential, randomly generated alphanumeric code. The alphanumeric code is configured to be one or more of directly applied to the product and applied to a label configured to be affixed to the product.

Throughout this application, the term “product” refers to an individual product item rather than a class of nominally identical products such as, for example, printers of a specific make and model.

Embodiments of the invention employ a specialized computer uniquely adapted to carrying out the methods and systems outlined in this application. This specialized computer utilizes artificial intelligence simultaneously to engage with thousands or millions or even billions of authorized computer users, each in their own language, using the translation capabilities outlined in more detail below, and to manipulate the data that is submitted by those users in real time in order to perform one or more of the various properties and functions newly disclosed in the present patent application. These properties and functions comprise one or more of: creating an alphanumeric code associated with a product; associating the alphanumeric code with an individual product passport of the product; enabling authorized system users to associate with the product passport product information relating to the supply chain of the product; enabling authorized system users accessing the system to associate with the product passport product information relating to the supply chain of the product, the product information comprising one or more of an updated data record regarding the individual product item and a new data record regarding the individual product item; obtaining system applicant information regarding a system applicant, the system applicant information comprising one or more of an updated data record regarding the system applicant and a new data record regarding the system applicant; validating the received system applicant information including checking for a discrepancy in the system applicant information; validating the received product information including checking for a discrepancy in the product information; presenting product information to the system user; presenting the product information in comparison to other product information pertaining to other comparable products; presenting the product information in comparison to other product information associated with comparable system users; and combining the records about one or more of multiple system users and multiple individual product items to provide analytic insights to a system user requesting the analysis. The analytic insights include, for example, a geographic distribution of usage of vaccines recorded on the system. Another example of analytic insights includes locations for disposal at end of life of a consumer good of a certain type.

Such a specialized computer is the only means of executing these functions, which are disclosed in greater detail throughout this application and the drawings, at the needed scale of number of users and number of operations.

For example, the product passport comprises a record of one or more of where the individual product is offered for sale, when the individual product is offered for sale, and a purchaser of the individual product. For example, the product passport comprises an electronic template file. For example, the product passport describes a life cycle of a pallet comprising one or more products. For example, the product passport describes a life cycle of a container comprising one or more products. For example, the product comprises one or more component products. A product passport for a given product may comprise a product passport for one or more of the component products. Alternatively, or additionally, a component product may have associated with it a separate, dedicated product passport describing a life cycle of the component product.

The product passport is uniquely associated with an individual product item, which as mentioned above, for purposes of this application, is also called a product. So, for example, for a class of printers of a specific make and model, each of which would have the same Universal Product Code (“UPC”) under the prior art UPC system, the product information system assigns a different product passport code to each product. The product passport is created independently of a system participant of an individual product on a specific product information system. Embodiments of the present invention further relate to a method of associating with the individual product further product information relating to that product. For example, the product information associated with the product relates to any portion of a life cycle of the product. For example, the product information system saves product information associated with the product as an independent record. For example, using the product passport, the product information system associates the product information with the product.

A product comprises one or more of a tangible product and an intangible product. For example, the tangible product has a physical structure, such as a computer. For example, the intangible product comprises a virtual product. For example, an intangible product comprises one or more of a licensed software product, a download of a virtual image, and another intangible product.

For example, the individual product comprises one or more of a food, a medicine, a manufactured product, a virtual product, a combination of a plurality of component products, and a bundling of a product into a larger package. For example, the plurality of component products comprises at least two component products configured to be combined for sale. For example, the at least two component products are configured to be packaged for sale. For example, at least one of the component products is manufactured. For example, each of the component products is manufactured. For example, the at least two component products comprise a compact disc (CD) player and a set of speakers. For example, the component products comprise chemicals configured to be combined to produce one or more of a food, a hygiene product, and a medical product. For example, the food comprises a microwavable meal. For example, the hygiene product comprises a shampoo. For example, the medical product comprises a vaccine. For example, the product comprises a computer, and the component product comprises a microprocessor. Examples of integration include incorporating a microprocessor into a computer, replacing a light bulb in a headlamp assembly of an automobile, and integrating a printer and toner cartridge into one package. For example, the bundling is done in order to arrange for transit of the product. For example, the bundling is done in order to arrange for transit of the product between logistics hubs. For example, the bundling comprises placing a product in one or more of a pallet and a shipping container.

A system user of a product has a relationship to the product comprising one or more of a grower, a collector, a harvester of materials, an extractor of materials, a manufacturer, an integrator of other manufactured products to make one or more of a bundle of products and a new product, a transporter, a repairer, a retailer, a wholesaler, an end user, and a disposer. A manufacturer comprises one or more of a manufacturer of the product, an integrator of the product, a formulator of the product, an assembler of the product, a cook of the product, and a supplier of one or more of a raw material, a part, and an ingredient needed to manufacture the product. The product integrator makes one or more of a new product and a bundle comprising a plurality of products. The system participant registers itself on the product information system in order to secure access to the product information system. In order to complete registration, the product information system must make a positive validation decision regarding the system participant's credentials. Preferably, but not necessarily, a system participant will supply more information and will be required to satisfy more validation requirements imposed by the product information system of the system user's submitted system user information against system user-related third-party information in order to register and to use the product information system than would be required of an end user who simply wants to access basic system user information about the manufacturer that has contributed to creation of the product that they are contemplating purchasing. Alternatively, or additionally, the system participant accesses product information regarding the product itself.

A transporter comprises one or more of a storer of the product, a shipper of the product, an aggregator of the product, an installer of the product, and an activator of a warranty of the product. An end user comprises one or more of a business, a consumer, a doctor, and a patient. For example, the product comprises a first product. For example, a repairer integrates the first product into a second product in place of a third product. For example, the third product is one or more of worn out and broken. For example, the first product comprises an automotive light bulb. For example, the third product comprises an automotive light bulb. For example, the second product comprises a car headlamp unit within which the first and third products are specifically designed to fit and to operate.

Additional embodiments of the present invention relate to a method of associating with the unique product passport, at the time of manufacture, manufacturer information relating to the product. For example, the manufacturer information comprises one or more of item-specific manufacturer information provided by the manufacturer of the product and product-related third-party information provided by a third-party. The product information server is configured to extract from a product passport item-specific information regarding that product. The product information server is further configured to extract from a product passport of a related product that is related to the product, product-related information regarding a related product related to the product item. Typically, but not necessarily, the same information comprises both item-specific information regarding the product item and product-related information regarding the related product related to the product item. Alternatively, or additionally, the product information server receives the product-related information relating to the product from at least one of a third-party information source and a system user associated with one or more of manufacture related to the product and supply chain operations related to the individual product. The product passport enables a system user to access information regarding the supply chain of the product. The product passport's alphanumeric code is configured to be usable by the system user to associate with the product passport product information relating to the supply chain of the product. For example, the supply chain begins at a time of manufacture of the product. For example, the supply chain ends at an end of life of the product. For example, the product information comprises an updated data record regarding the individual product item. For example, the product information comprises a new data record regarding the individual product item.

For example, the manufacturer information comprises an independent review of manufacturing conditions when the product was manufactured. For example, the manufacturer information comprises a product limitation. For example, the product limitation comprises a limitation on one or more of when the product can be sold, how the product can be sold, and where the product can be sold. For example, the product limitation comprises one or more of a sanction control, a regulatory standard, and a product performance limitation. For example, the product performance limitation comprises an environmental product performance limitation. For example, the environmental product performance limitation comprises a performance of the individual product relative to one or more of a previously manufactured product of a same type as the product and a subsequently manufactured product of the same type as the product. For example, due to a difference in performance of a component product obtained from different suppliers, the environmental performance limitation can be important in verifying product functionality. As a specific example, three different companies may make a sound card for a computer, any one of which can be integrated into the computer depending on one or more of a date of manufacture and an availability of the component product.

The product information system is configured to receive product information regarding a product as the product passes through a supply chain, for example, a supply chain passing from a manufacturer of the product, to a transporter of the product, to a retailer of the product, to a consumer of the product, to a disposer of the product. The product information system is further configured to receive product information regarding the product from a trusted third-party information source lying outside the supply chain for the product.

The product information includes the unique alphanumeric code for the product passport of the individual product. The product information system associated the product information with the product passport. The product information system saves the product information. When the product information system receives a product information request for the product supply chain information from a system participant, the product information system looks up the product information associated with the individual product and responsive to the system participant's request. For example, the system participant comprises a potential purchaser of the individual product. For example, when the product information system receives the product information request, using the product passport's unique alphanumeric code, the product information system looks up the product information associated with the individual product. The product information system transmits to the potential purchaser the product information associated with the individual product and responsive to the system participant's request.

Other embodiments of the present invention relate to a method of providing access to the product passport using the product information system, thereby showing a real-time record of a life of the product. For example, the real-time record begins at a time of manufacture of the product. For example, the real-time record ends at an end of life of the product. For example, the real-time record begins at the product's time of manufacture and the real-time record ends at the product's end of life. For example, the end of life comprises a time when the product is one or more of consumed, recycled and destroyed. Further embodiments of the present invention relate to the product information system receiving, from a system user, system user product information relating to the product. Additional embodiments of the invention relate to the product information system adding the system user product information to the product passport. For example, the system user product information comprises one or more of a product location, a product storage method, product insurance coverage, and a financial charge relating to the product. For example, the product information system records the product location. For example, the product location comprises a real-time product location. For example, the product storage method comprises a product storage method during product transit. For example, the product storage method comprises refrigeration. For example, the financial charge is secured on the product.

Still further embodiments of the present invention relate to the product information system receiving, from an end user, end user product information relating to the product. For example, the end user product information comprises one or more of when, where, and how the product was used. For example, how the product was used comprises one or more of how the product was consumed, recycled, and destroyed. For example, the end user product information comprises one or more of a product location, a product storage method, product insurance coverage, and financial charges secured on the product. For example, the product location comprises a real-time product location. For example, the product storage method comprises a product storage method during product transit. For example, the product storage method comprises refrigeration. Still other embodiments of the invention relate to the product information system associating with the product passport one or more of the system user information and the end user product information. Yet other embodiments of the invention relate to the product information system providing to a requester of the product information product information comprising one or more of the manufacturer product information, the system user product information, and other product information comprised in the unique product passport.

The requester can request product information for reasons other than a prospective purchase. For example, the researcher requests product information for purposes of analysis of one or more of a particular system participant, a system participant type, a system participant location, a product location, and another product information criterion. For example, the system participant type comprises one or more of a type of system participant and a type of system participant associated with a particular product type. For example, the requester requests the product information regarding a particular brand of refrigerators manufactured by a certain company, Kuangdong Manufacturing, which is based in China. For example, the requester requests the product information for purposes of analysis of a system participant location. For example, the requester requests the product information regarding all China manufacturers of large capacity refrigerators.

For example, according to yet additional embodiments of the invention, the requester can use the product information system to obtain in real time product information regarding one or more of a composition of the product, location information regarding the product, a present use of the product, a past use of the product, and an end of life status of the product. It should be noted that it would not be remotely possible for a human, using pencil and paper, to hypothetically mimic this invention, since aside from requiring millions of computations per second, and a hypothetical human capable of fluently and instantaneously performing cross-translations in all human languages, the real time feature is only achievable using a specialized computer, as disclosed elsewhere in this application. The end of life status of the product comprises one or more of a consumption status of the product, a recycling status of the product, and a destruction status of the product. For example, the location of the product comprises one or more of how the product has been stored, where the product has been stored, a current owner of the product, and whether a finance charge currently attaches to the product. For example, the product comprises a component product, the component product having its own product passport. For example, the location information comprises storage information, possession information, ownership information, and a finance charge attached to the product. For example, ownership comprises possession.

Embodiments described herein allow for a purchaser, such as one or more of a consumer, a clinician and a retailer, to obtain in real time information from the product information system about a particular product that the purchaser is considering purchasing, using, or consuming. The purchaser comprises one or more of a consumer, a clinician, and a retailer.

The methods and systems for using a product passport for providing item-specific product information are also configured to create an auditable trail of one or more of product ownership and product possession for the product.

In one particular embodiment, the product information system receives a product passport comprising product information relating to an individual product. For example, the product information system receives the product passport from a manufacturer of the product. The product information relating to the individual product includes characteristic information about the individual product and the product passport's unique alphanumeric code. The characteristic information includes one or more of a date of manufacture, a time of manufacture, a location of manufacture, a representative retailer price of purchase, a representative end user price of purchase, a product code, the manufacturer's name, the manufacturer's address, the manufacturer's email address, the manufacturer's telephone number, the manufacturer's facsimile number, the manufacturer's social media handle, manufacturer person hours used to manufacture the product, a manufacturer staff member participating in manufacturing the product, product composition information, and other characteristic information. The product composition information includes one or more of labor content relating to the product's manufacture, a factory condition for a factory in which the product was manufactured, a chemical ingredient information regarding a chemical used in manufacturing the product, a source of the chemical ingredient, a quantity of the chemical ingredient, a component product of the product, and other product composition information. The labor content may compel manufacturers to improve one or more of labor standards, factory conditions, chemical ingredient quality, and the like.

Embodiments of the invention therefore have the potential to have an impact on other technology areas including one or more of medicine, an environmental impact of a product, and human rights. For example, the chemical ingredient information comprises information regarding one or more of a source, a type, and a quantity of the chemical. The chemical ingredient information includes one or more of a batch code of the chemical and other chemical ingredient information. The product information system stores the product passport. Alternatively, or additionally, the product information system associates the product passport with the product. The product information system receives audit trail information from the manufacturer indicating a change of one or more of product possession and product ownership. For example, the audit trail information further comprises information regarding a system user that receives the product after the change of product ownership. For example, the audit trail information further comprises the product passport's alphanumeric identifier. Information identifying the system user is also received from the manufacturer or from the system user. The product information system stores the product supply chain information. The product information system associates the product passport's unique alphanumeric code with the individual product.

Thus, the product information system's product passport uniquely identifies an individual product. Alternatively, or additionally, the product passport comprises a possession trail of the product. Alternatively, or additionally, the possession trail comprises an ownership trail of the product. In certain circumstances, such as while the product is being transported, a possessor of the product does not comprise an owner of the product. For example, the product information system's product passport follows the ownership trail throughout a life cycle of the product.

Thus, the product information supplied by a manufacturer can be compared and validated at least in part against an independent, reputable source. For example, a system user accesses the product information system and the system user interrogates a product passport. The product information system responds to the product information request by sending a request response to the system user. The request response comprises one or more of item-specific information comprised in the product passport record and product-related information regarding a related product related to the product item.

For example, the product information request comprises a item-specific information request regarding the product item. For example, the product information request comprises a product-related information request regarding a plurality of products comprising the product item. For example, the system user requests product-related information regarding products nominally identical to the product item. For example, the system user requests product-related information regarding products similar to the product item. For example, the product item comprises a laptop computer. For example, the system user requests item-specific information regarding the specific laptop computer identified by the alphanumeric code. For example, the system user requests product-related information regarding laptop computers of a same product number as the product item. For example, the system user requests product-related information regarding laptop computers of a same brand as the product item. For example, the system user requests product-related information regarding laptop computers of a same product number as the product item and available for purchase within a certain geographic region. For example, the system user requests product-related information regarding laptop computers of a same Universal Product Code (UPC) number as the product item and available for purchase within a certain geographic region. For example, the system user requests product-related information regarding laptop computers of a same brand as the product item and available for purchase within a certain geographic region. For example, the system user requests a geographic distribution of usage of vaccines recorded on the system. For example, the system user requests locations for disposal at end of life of a consumer good of a certain type.

For example, the system user requests product-related information regarding Dell laptops of a certain item number available worldwide. For example, the system user requests product-related information regarding all known Dell laptops available worldwide. For example, the system user requests product-related information regarding Dell laptops of a certain item number available in New York City. For example, the system user requests product-related information regarding all known Dell laptops available in New York City.

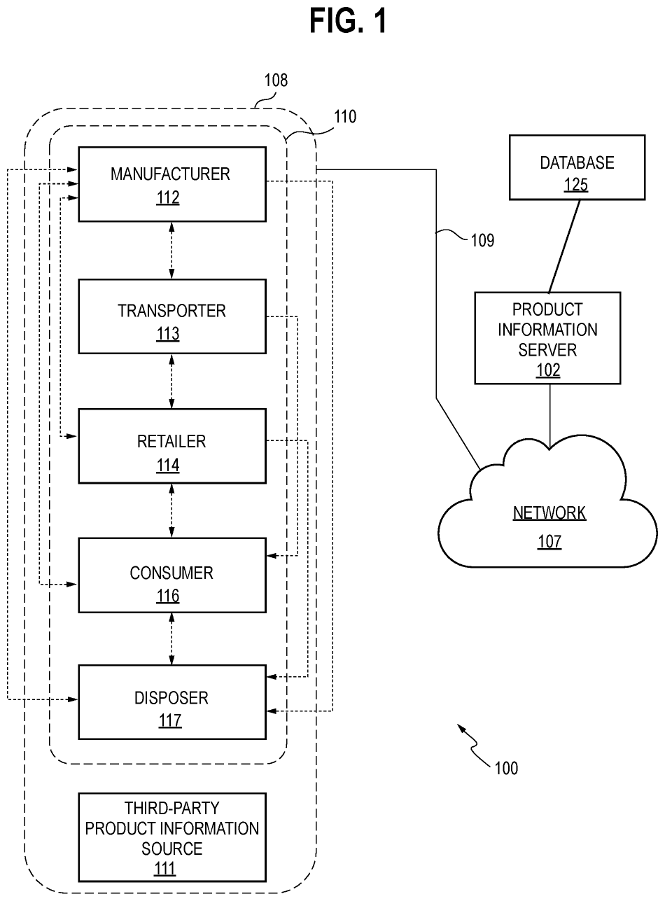

FIG. 1 is a schematic diagram of a product information system for using a product passport for providing item-specific product information. The product passport comprises a unique alphanumeric code. FIG. 1 illustrates a product information system 100 in which, using the product passport that the product information system creates, the product information system can do one or more of provide product information and verify product information. The product information system 100 includes a product information server 102, the product information server 102 configured to create a product passport regarding a product, provide product information and verify product information. The product information server 102 is further configured to gather product information over a network 107 usable by the product information server to gather the product information. The product information server 102 is further configured to gather the product information over the network 107 from a system participant 108, the system participant 108 operably connected via a system-participant-server operable connection 109 to the product information server 102 over the network 107.

The system-participant-server operable connection 109 is configured to operably connect the system participant 108 to the product information server 102 via the network 107. The system participant 108 comprises one or more of a system user 110 and a third-party information source 111 configured to provide information regarding the product. The system user 110 comprises one or more of a grower configured to grow the product, a collector configured to collect product components to create the product, a harvester of materials configured to harvest materials used to create the product, an extractor of materials configured to extract materials used to create the product, a manufacturer 112 configured to contribute to manufacturing of a product, an integrator of other manufactured products to make one or more of a bundle of products and a new product, a transporter 113 configured to change a location of a product, a repairer, a retailer 114 configured to offer a product for sale, a wholesaler, an end user 116 configured to do one or more of use and consume a product, and a disposer 117 configured to dispose of the product.

For convenience, in most of the discussions of embodiments of the invention as well as in the figures, this application focuses on a system participant 108 comprising one or more of the third-party information source 111, the manufacturer 112, the transporter 113, the retailer 114, the end user 116, and the disposer 117. As depicted, the system participant 108 comprises one or more of the third-party information source 111, the manufacturer 112, the transporter 113, the retailer 114, the end user 116, and the disposer 117. The other system participants 108 are also parts of the system 100, the other system participants 108 comprising but not necessarily limited to one or more of the grower, the collector, the harvester, the extractor, the integrator, the repairer, and the wholesaler,

As depicted, the system participants 108 other than the third-party information source 111 are collectively termed system users 110, the system users 110 being configured to use the system 100. As depicted, the system user 110 comprises one or more of the manufacturer 112, the transporter 113, the retailer 114, the end user 116, and the disposer 117. The other system users 110 are also parts of the system 100, the other system users 110 comprising but not necessarily limited to one or more of the grower, the collector, the harvester, the extractor, the integrator, the repairer, and the wholesaler. The system participant 108 comprises one or more of the system user 110 and the third-party information source 111.

For example, the transporter 113 comprises one or more of a logistics hub, and a hauler. The system user 110 comprises one or more of the manufacturer 112, the transporter 113, the retailer 114, the end user 116, and the disposer 117. Preferably, and most commonly, but not necessarily, the system user 110 comprises part of a supply chain of the product. Connections between system users 110 are not part of the system 100 and thus are indicated in FIG. 1 using dotted lines. Typically, but not necessarily, at least two of the manufacturer 112, the transporter 113, the retailer 114, the end user 116, and the disposer 117 are operably connected to each other. For example, the at least two of the manufacturer 112, the transporter 113, the retailer 114, the end user 116, and the disposer 117 are operably connected to each other over the network 107. Preferably, but not necessarily, each of the manufacturer 112, the transporter 113, the retailer 114, the end user 116, and the disposer 117 are operably connected to each other. For example, each of the manufacturer 112, the transporter 113, the retailer 114, the end user 116, and the disposer 117 are operably connected to each other over the network 107. For example, an operable connection between the manufacturer 112 and the end user 116 can facilitate a direct sale of the product to the end user 116 by the manufacturer 112. Alternatively, or additionally, the operable connection between the manufacturer 112 and the end user 116 enables the end user 116, using the product information system, to make inquiries regarding the product to the manufacturer 112. The retailer 114 is operably connected to one or more of the manufacturer 112, the transporter 113, the end user 116, and the disposer 117. The end user 116 is operably connected to the retailer 114.

The disposer 117 comprises one or more of a recycler, a refurbisher, and trash. For example, disposal comprises one or more of consumption, recycling, destruction, and another disposal method.

The system 100 further comprises a database 125, the database 125 operably connected to the product information server 102. The database 125 is configured to hold one or more of the product passport information and the product's unique alphanumeric code. The database further comprises one or more of system user information and product information. Preferably, but not necessarily, the database comprises both the system user information and the product information. For example, the product information comprises product manufacturer information the manufacturer 112 provides. For example, the product information comprises product information provided by other system users 110 other than the manufacturer 112, for example, one or more of the retailer 114, the end user 116, and the third-party information source 111. Information directly related to the product by other system users (such as one or more of a change of storage location, an aggregation into another product, and the like). The database 125 also holds ownership information of the individual products. The database 125 also holds third-party information provided by the third-party information source 111.

The system user 110 accesses product information. For example, the system user 110 can access the product information comprised in the system 100 using as a system user device one or more of a mobile phone, a laptop computer, a desktop computer, a tablet, and another device. For example, using the system user device, a consumer in a store can input the product passport's unique alphanumeric code. For example, the consumer can input the alphanumeric code by doing one or more of typing, using optical character recognition, using bar code recognition, and using QR code recognition. For example, the consumer can input the alphanumeric code using one or more of a web browser, a store kiosk, a mobile phone, a laptop computer, a desktop computer, a tablet, another device, and an interactive telephone service.

For example, the product information server 102 further comprises one or more of a Web server (not shown), an application server (not shown), and a database server (not shown). The database server is operably connected to the database 125. Preferably, but not necessarily, the product information server 102 comprises the Web server, the application server, and the database server. The Web server is configured to provide the system user 110 with access to the product information server 102 and thus to provide the system user 110 with access to the product information system 100. The application server is configured to process a request from the system user 110. The application server is further configured, using the Web server, to provide access for the system user 110 to the database server. The database server comprises an archiving system accessible by the application server in order to do one or more of inserting, using one or more of the Web server and the application server, product information supplied by the system user 110 into the database server and extracting, using the Web server, product information requested by the system user 110. In the latter case, after extracting the product information, the database server, using the Web server, provides the requested, extracted product information back to the system user 110. The Web server hosts one or more of a web page and an application usable to process a request received from the system user 110.

Preferably, but not necessarily, the Web server hosts one or more of a web page, an application, and a payment technology usable to process a request received from the system user 110. Most preferably, but not necessarily, the Web server hosts the web page, the application, and the payment technology usable to process the request received from the system user 110. For example, the Web server directs the request to the application server, which provides application-specific functionality and returns to the Web server a result responding to the request. For example, the result comprises one or more of a registration of a user of the product information system, a validation of a user of the product information system, a receipt of a payment for a result of the product information system, a creation of a product passport, a transmission to a user of a product's unique alpha-numeric code, an insertion into an individual product passport of received product information, an augmentation of the product passport over a life cycle of the item with product contextual information received from an authorized source, a reception of product third-party information, a processing of product third-party information, and a response to a user request. For example, the user request comprises a request for product information from a product passport.

For example, the database server hosts product information comprising one or more of product passport information, associated product third-party information, and product contextual information. For example, the database server downloads the product information from the application server. For example, in response to an inquiry to the product information server 102 by the system user 110, the database server makes a request to the application server, and the application server manipulates the product information. For example, in response to an inquiry to the product information server 102 by the system user 110, the application server does one or more of format the product information and present the product information.

The web server, the application server, and the database server can communicate with one another over a network (not shown) such as a local area network (LAN) or wide area network (WAN). The product information that the product information system 100 stores in the database 125 will vary depending on, one or more of a product produced by the manufacturer, product life cycle audit information, and available product contextual information.

For example, the network comprises one or more of a local network and a wide area network such as the Internet. For example, the third-party information source 111 comprises one or more of an independent researcher, a third-party information source, a financier, an insurer, and another third-party information source.

For example, the product information comprises one or more of the product's unique alphanumeric code, product basic information, product component information, product manufacture information, product manufacturer information, product comparison information, product untoward information, and product contextual information. Preferably, but not necessarily, the product information comprises the product's unique alphanumeric code, the product basic information, the product component information, the product manufacture information, the product manufacturer information, the product comparison information, the product untoward information, and the product contextual information.

Alternatively, or additionally, the product information system obtains the product manufacturer information from the system applicant information submitted by the product manufacturer when registering as a system user. For example, the product information server provides the manufacturer with a form usable by the manufacturer to input the product manufacturer information. Alternatively, or additionally, the application server receives from the manufacturer an upload of the product manufacturer information.

For example, the product basic information comprises one or more of a product type, a product manufacturer name, a product manufacture date, a product manufacture time, a product manufacture location, a product system user language, a product system user location, a product component product passport's unique alphanumeric code, a product recall notice, a product shipping date, a product shipping time, a product typical wholesale price, a product typical retail price, a product code, a product description, a product number, a product Universal Product Code (UPC), a product location within a supply chain, and an exact product specification. The product component product passport comprises a product passport of a component of the product. The product component comprises one or more of a component of the product, a product ingredient, a raw material used in creating the product, a chemical used in creating the product, and a product part.

For example, the product component information comprises one or more of product raw material information, product ingredient information, and product chemical information. For example, the product raw material information comprises one or more of a raw material type, a raw material quantity, a raw material source, a raw material performance, and other raw material information. For example, the product ingredient information comprises one or more of an ingredient type, an ingredient quantity, an ingredient source, an ingredient performance, and other ingredient information. For example, the product chemical information comprises one or more of a chemical type, a chemical quantity, a chemical source, a chemical performance, and other chemical information.

For example, the product manufacture information comprises one or more of a product manufacture skill level, a product manufacture wage level, a product manufacture machine, a product manufacturing process step duration, a representative product manufacture wastage, a representative product manufacture error level, a representative product manufacture method, regional product manufacture information, a resource used in manufacturing the product, end user warranty registration information, end user medication use recording information, a user handbook, medical prescription guidance, and other product manufacture information. For example, the regional product manufacture information comprises information for a region in which the product is manufactured regarding one or more of a representative wage, a worker safety standard, a worker health standard, manufacturer labor compliance information, manufacturer labor certification information, a manufacturer environmental standard, and a manufacturer ethical standard.

For example, the product manufacturer information comprises information submitted by the product manufacturer as a system applicant when registering on the product information system. For example, the product manufacturer information comprises the system applicant information submitted by the manufacturer.

For example, the product untoward information comprises information indicating that the product may comprise untoward aspects. For example, the product untoward information comprises one or more of information regarding a stolen product, a defective vaccine, a problematic vaccine dose, likely damage to the product, a product subject to a finance charge, a product subject to a past back door sale, product content dilution, a corrupt medical product, and a product manufactured using one or more of unpermitted sub-contracting, slavery, and sweatshop conditions.

For example, the product comparison information comprises product information for a comparable product. For example, the product comparison information comprises product information for a comparable product previously registered on the system. For example, a third-party information source provides the product comparison information. For example, the product comparison information comprises one or more of comparable product raw material information, comparable product ingredient information, and comparable product chemical information. For example, the comparable product raw material information comprises one or more of a raw material type, a raw material quantity, a raw material source, a raw material performance, and other raw material information. For example, the comparable product ingredient information comprises one or more of an ingredient type, an ingredient quantity, an ingredient source, an ingredient performance, and other ingredient information. For example, the comparable product chemical information comprises one or more of a chemical type, a chemical quantity, a chemical source, a chemical performance, and other chemical information.

The product contextual information comprises broader product information indirectly relating to one or more of the product, a resource used in creating the product, a resource used in using the product, a material context of the product, a geographical context of the product, a human context of the product, and an economic context of the product. For example, the product contextual information comprises third-party information source information relevant to the product, including one or more of a regional labor rate in a region where the produce is manufactured, a review of the product by a third-party authority, an independent review of reliability of the product relative to comparable products, and the like. For example, the product contextual information comprises one or more of human rights information, labor information, environmental impact information, cost information, insurance information, and other contextual information. The product information system correlates the product contextual information with the product information directly pertaining to the product.

For example, the retailer 114 logs into the product information server 102 to check on a number of available particular individual product items that can be purchased by the retailer 114 for resale. For example, the individual product item comprises a laptop computer. For example, the end user 116 logs into the product information server 102 to check on whether a particular individual product item is in stock.

The product information system 100 is configured to provide information about the product to the end user 116 at a point-of-sale. For example, in a case in which the product comprises a medicine, the product information system 100 informs a medical clinician how to administer the product to the patient.

Some business entities do not have a manufacturing or distribution infrastructure, but instead have agreements with contract manufacturers who supply part products and with other parties who assemble, package and distribute the final products. Thus some business entities may merely coordinate supply chain operations, for example from the initial supplier to the final customer, and which may include any one or more of supplying, manufacturing and distributing of the products.

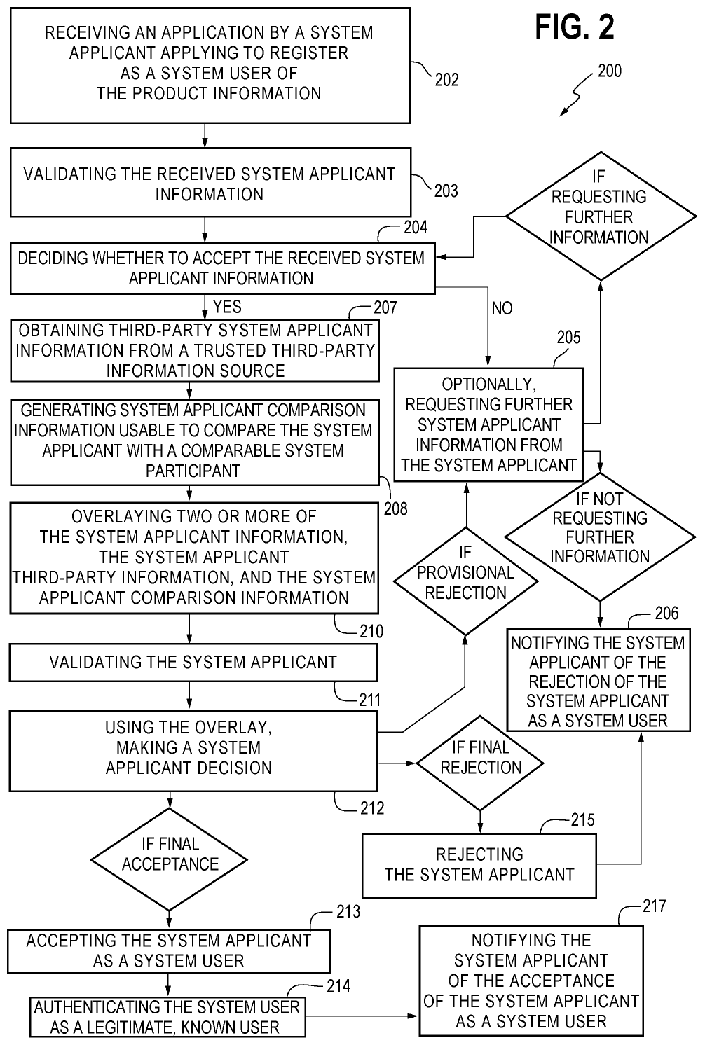

FIG. 2 is a flow chart of a method 200 for using a product passport and a product information system for providing item-specific product information. More specifically FIG. 2 is a flow chart of a method 200 for deciding, using a product passport and a product information system using a product passport for providing item-specific product information, an application by a system applicant applying to register as a system user of the product information system.

The order of the steps in the method 200 is not constrained to that shown in FIG. 2 or described in the following discussion. Several of the steps could occur in a different order without affecting the final result.

In step 202, the product information system, using a product information server, receives system applicant information from a system applicant applying to register as a system user of the product information system. For example, the system applicant comprises one or more of a manufacturer, a transporter, a retailer, an end user, a disposer, and a third-party information source. For example, the application comprises system applicant information. For example, the system applicant information comprises one or more of system applicant basic information and other system applicant information.

Preferably, but not necessarily, the step of receiving the system applicant information comprises providing the system applicant, by the product information system, using the product information server, with a transmission method for transmitting to the product information server the system applicant information. Preferably, but not necessarily, the transmission method comprises uploading the product information from the system applicant using a prescribed electronic product information upload form. Preferably, but not necessarily, the system applicant information comprises one or more of a system applicant language and a system applicant location. Preferably, but not necessarily, the product information system, using the product information server, uses the system applicant location to determine one or more system applicant languages used in the system applicant location. Preferably, but not necessarily, the product information system, using the product information server, translates the product information into the system applicant language. Preferably, but not necessarily, the product information system, using the product information server, translates the upload form to the system applicant language.

For example, the system applicant basic information comprises one or more of a system applicant name, a system applicant address, a system applicant email address, a system applicant telephone number, a system applicant's facsimile number, a system applicant social media handle, a system applicant company registry number, a system applicant tax reference number, a product type manufactured by the system applicant, a number of factories operated by the system applicant, an origin of a component used by the system applicant, a criminal record of the system applicant, a factory condition in a factory operated by the system applicant, and other information regarding the system applicant.

For example, the system applicant comprises a third-party information source. For example, the system applicant provides system applicant information about itself as part of the login process. For example, the system applicant information comprises one or more of a system applicant name, a system applicant address, a system applicant email address, a system applicant telephone number, a system applicant's facsimile number, a system applicant social media handle, a system applicant company registry number, a system applicant tax reference number, a product type manufactured by the system applicant, a number of factories operated by the system applicant, an origin of a component used by the system applicant, a criminal record of the system applicant, a factory condition in a factory operated by the system applicant, and other information regarding the system applicant. For example, the login process further comprises payment, by the system applicant, using the server, of an applicable registration fee. Block 202 then transfers control to block 203.

In step 203, the product information system, using the product information server, validates the received system applicant information. For example, the product information server validates the received system applicant information using artificial intelligence. Validation comprises critically reviewing the received system applicant information in preparation to do one or more of accept the received system applicant information and reject the received system applicant information.

The validation step comprises checking for one or more of system applicant information mis-entry by the system applicant, fraud, and another discrepancy. For example, if the system applicant states that the factory pays twice the prevailing wage, but the system applicant comparison information states that the factory pays below the prevailing wage, the validation process identifies the discrepancy. Block 203 then transfers control to block 204.

In step 204, the product information system, using the product information server, decides whether to accept the received system applicant information. If the product information server determines that agreement between the received system applicant information and the system applicant comparison information is sufficient, the product information server accepts the received system applicant information. If the product information server determines that the agreement is not sufficient, the product information server rejects the received system applicant information.

The product information server can decide to accept a portion of the received system applicant information while rejecting a remaining portion of the received system applicant information, in which case the method branches depending on which portion of the received system applicant information is being addressed. If the product information server decides to accept the received system applicant information, block 204 then transfers control to block 207. If the product information server decides to reject the received system applicant information, block 204 then transfers control to block 205.

In step 205, optionally, the product information system, using the product information server, requests further system applicant information from the system applicant. For example, in the case discussed above regarding step 204 of the disagreement about the wage paid by the system applicant's factory, the product information server requests the system applicant to verify all wage information regarding the factory in order to resolve the identified discrepancy.

Optionally, the product information server then receives the requested further system applicant information from the system applicant. For example, the further system applicant information comprises a new data record regarding the system applicant. For example, the further system applicant information comprises an updated data record regarding the system applicant. For example, the further system applicant information comprises a new data record regarding the system applicant.

Optionally, the product information server validates the received further system applicant information. Validation comprises critically reviewing the received further system applicant information in preparation to do one or more of accept the received further system applicant information and reject the received further system applicant information. For example, the product information server validates the received further system applicant information using artificial intelligence.

The validation step again comprises checking for one or more of system applicant information mis-entry by the system applicant, fraud, and another discrepancy. For example, if the system applicant states that the factory pays twice the prevailing wage, but the system applicant comparison information states that the factory pays below the prevailing wage, the validation process identifies the discrepancy.

The product information system can request further system applicant information as many times as needed to evaluate a system applicant's application. If the product information server requests further system applicant information, the process loops back to block 204 and the product information server decides whether to accept the received further system applicant information. If the product information server does not request further system applicant information, the process continues to block 206.

In step 206, the product information system, using the product information server, rejects the system applicant and then notifies the system applicant of the rejection of the system applicant by the product information system. Block 206 then terminates the process.

In step 207, the product information system, using the product information server, obtains third-party system applicant information from a trusted third-party information source. The third-party system applicant information comprises one or more of third-party applicant information regarding the system applicant and system applicant comparison information relevant to evaluation of the application of the system applicant. For example, system applicant comparison information comprises information regarding an average regional wage in a region of manufacture where the system applicant's factory is located. For example, the third-party information source comprises one or more of a federal company registry, a federal tax registry, a state company registry and a state corporate tax registry. Block 207 then transfers control to block 208.

In step 208, the product information system, using the product information server, generates system applicant comparison information usable to compare the system applicant with a comparable system participant. For example, generating comprises one or more of obtaining and locating. For example, obtaining comprises obtaining from one or more of the trusted third-party source and the comparable system participant. For example, generating comprises locating system applicant comparison information from system participant information relating to the comparable system applicant and comprised in the product information system.

For example, the product comparison information comprises product information for a comparable product. For example, the product comparison information comprises product information for a comparable product previously registered on the system. For example, a third-party information source provides the product comparison information.

For example, the comparable system participant comprises a system participant that shares with the system applicant one or more of a system applicant characteristic role, a system applicant corporate status, a system applicant corporate ownership, a system applicant physical location, a system applicant product type, a system applicant service type, a system applicant employee number, a system applicant revenue, a system applicant comparable product, a system applicant comparable service, a system applicant regulator standard compliance certification, a system applicant market, a system applicant licensed market, a system applicant language spoken, a system applicant sanction status, a system applicant financial rating, a system applicant product performance, a system applicant independent product rating, a system applicant service performance, a system applicant independent service rating, a system applicant product price, a system applicant service price, a system applicant corporate status, a system applicant ethical corporate status, a system applicant legal compliance record, a system applicant creditworthiness rating, and another comparable system applicant characteristic.

For example, the system applicant characteristic role comprises one or more of a grower, a collector, a harvester of materials, an extractor of materials, a manufacturer, an integrator of other manufactured products to make one or more of a bundle of products and a new product, a transporter, a repairer, a retailer, a wholesaler, an end user, and a disposer. For example, the system applicant corporate ownership is usable to monitor compliance with a sanction against one or more of the system applicant and the comparable system user. For example, one or more of the system applicant service price and the system applicant product price comprises a price range. For example, the system applicant corporate status comprises one or more of a private corporation, a public corporation, a public benefit B corporation, a C corporation, a non-profit corporation, an S corporation a limited liability (LLC) corporation, a public limited company (PLC) corporation, and another type of corporation. For example, the system applicant ethical corporate status varies according to a system applicant definition but may comprise one or more of a non-profit corporation and a public benefit B corporation.

For example, the comparable system participant comprises one or more of a manufacturer associated with the system applicant, a transporter associated with the system applicant, a retailer associated with the system applicant, an end user associated with the system applicant, a disposer associated with the system applicant, a comparable system user that is comparable with the system applicant, and a third-party information source comprising system applicant information relevant to validation of the received system applicant information. For example, the system applicant comprises a manufacturer, and the comparable system participant comprises a manufacturer. For example, the system applicant information is usable by the product information system to perform the validation by independently validating the received system applicant information. Block 208 then transfers control to block 210.

In step 210, the product information system, using the product information server, overlays two or more of the system applicant information, the system applicant third-party information, and the system applicant comparison information. Block 210 then transfers control to block 211.

In step 211, the product information system, using the product information server, validates the system applicant. Validation comprises critically reviewing the received system applicant in preparation to do or more of accept the system applicant and reject the system applicant. For example, the product information server validates the system applicant using artificial intelligence. Block 211 then transfers control to block 212.

In step 212, using the overlay, the product information system, using the product information server, makes a system applicant decision. For example, the step of making the system applicant decision comprises comparing two or more of the received system applicant information, the third-party system applicant information, and system applicant comparison information received from a comparable system participant.

The system applicant decision comprises one or more of a final system applicant acceptance, a final system applicant rejection, and a provisional system applicant rejection of the system applicant. The provisional system applicant rejection comprises a request, by the system to the system applicant for further system applicant information usable by the product information server to change the provisional system applicant rejection to one or more of a final system applicant acceptance and a final system applicant rejection. Thus, if the product information system decides on a provisional system applicant rejection, the system loops back to step 205 to request further information usable by the product information server to change the provisional system applicant rejection to one or more of a final system applicant acceptance and a final system applicant rejection. The system can make such requests for further system applicant information multiple times if the system deems this appropriate. If the product information system decides on a final system applicant acceptance, thereby accepting the system applicant as a system user, block 212 then transfers control to block 213. If the product information system decides on a final system applicant rejection, block 212 then transfers control to block 215.

In step 213, the product information system, using the product information server, accepts the system applicant as a system user. Block 213 then transfers control to block 214.

In step 214, the product information system, using the product information server, authenticates the system user as a legitimate, known user of the product information system. Block 214 then transfers control to block 217.

In step 215, the product information system, using the product information server, rejects the system applicant. Block 215 then transfers control to block 216.

In step 216, the product information system, using the product information server, notifies the system applicant of the rejection of the system applicant as a system user. Block 216 then terminates the process.

In step 217, the product information system, using the product information server, notifies the system applicant of the acceptance of the system applicant as a system user. Previously submitted system applicant information can now be alternatively referred to as system user information. Using the acceptance, through a system user device, the system user can do one or more of access and utilize the product information system in a manner which is consistent with the nature of their registration. Block 217 then terminates the process.

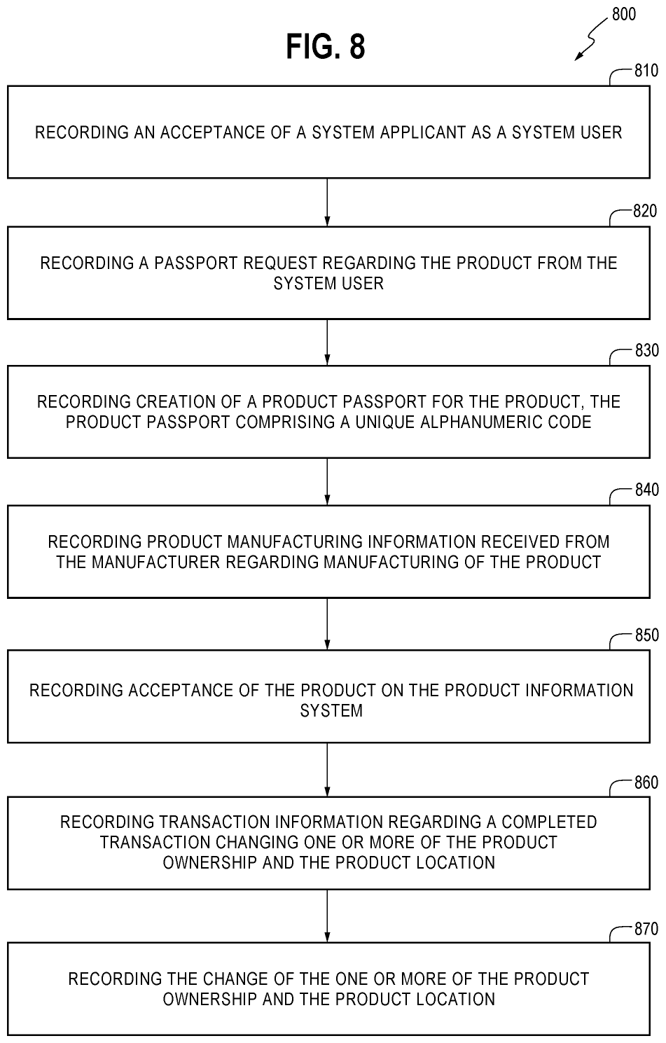

The method further comprises an optional additional step, performed after the populating step, of, using the product information system, using the product information server, creating an auditable trail of one or more of product ownership and product location. This method is set forth in more detail in FIG. 8 and in the associated independent claim.

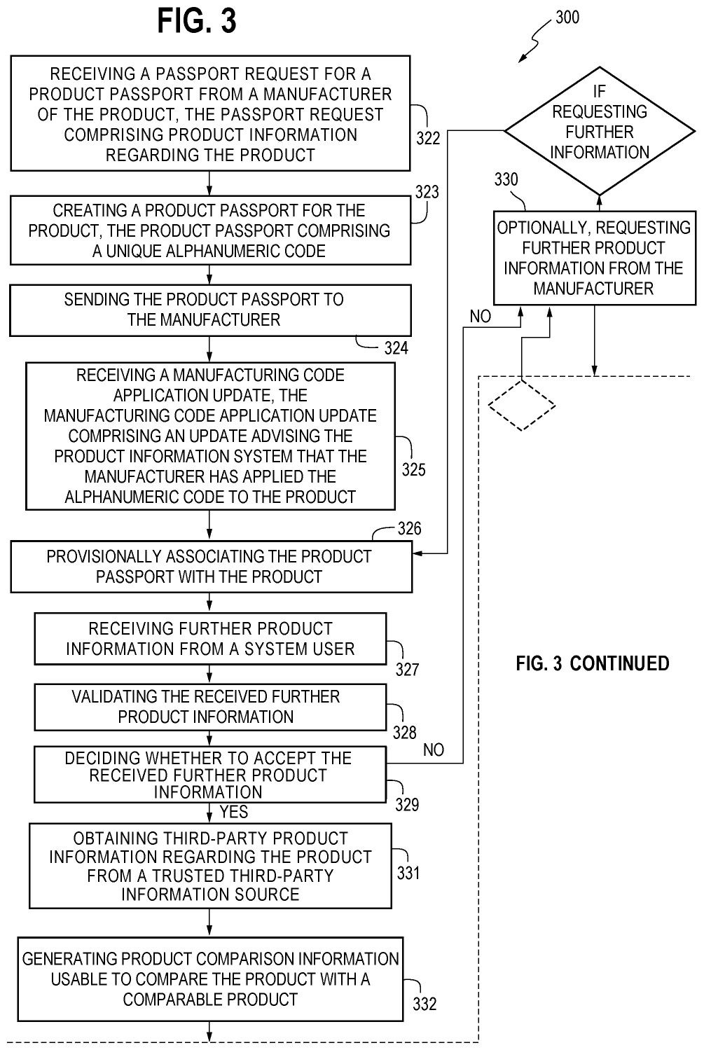

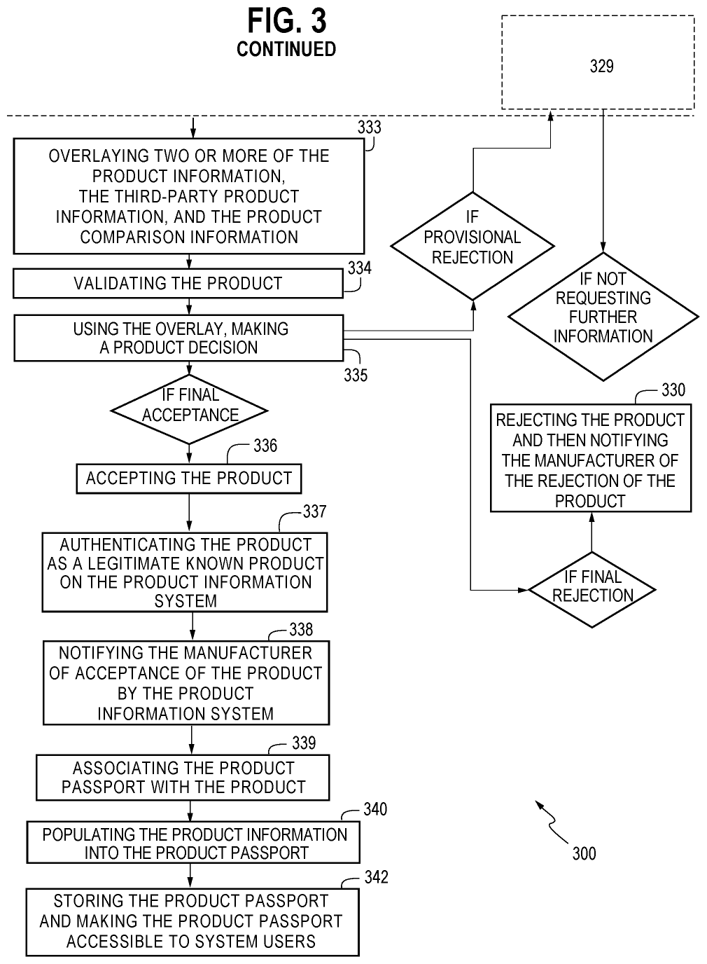

FIG. 3 is a flow chart of a method 300 for using a product passport and a product information system for providing item-specific product information. More specifically, FIG. 3 is a flow chart of a method 300 for creating a product passport and populating the product passport with item-specific product information. FIG. 3 focuses on an example in which the system user comprises a manufacturer. In this example, the manufacturer, after being accepted as a system user, is requesting a product passport for an individual product manufactured by the manufacturer.

The order of the steps in the method 300 is not constrained to that shown in FIG. 3 or described in the following discussion. Several of the steps could occur in a different order without affecting the final result.

In step 322, the product information system, using the product information server, receives a passport request regarding a product from a system user, the passport request comprising product information regarding the product. Preferably, but not necessarily, the product information comprises one or more of a product type, a product system user language, and a product system user location. Preferably, but not necessarily, the product information system, using the product information server, uses the product system user location to determine one or more product system user languages used in the product system user location.

For example, the system user comprises one or more of a manufacturer associated with the product, a transporter associated with the product, a retailer associated with the product, an end user associated with the product, and a disposer associated with the product. Most commonly, but not necessarily, the system user comprises the manufacturer of the product. To simplify the description, while any system user associated with a product can apply for a product passport for the product, this method describes the passport request submitted by the manufacturer. Accordingly, in step 322, the product information system, using the product information server, receives the passport request regarding the product from the manufacturer of the product, the passport request comprising product information regarding the product.

The passport request comprises a request that the product information system create a new, unique product passport for an individual product item manufactured by the manufacturer. The passport request can pertain to a product that is one or more of not yet manufactured, partially manufactured, and fully manufactured. The product can be in the possession of the requesting manufacturer. For example, the product information server comprises a web-based server. For example, the product information server comprises an application server. For example, the passport request further comprises payment, by the manufacturer, using the product information server, of an applicable registration fee.

The step of receiving the passport request with the product information comprises providing the manufacturer, by the product information system, using the product information server, with a method for transmitting to the product information server the product information.

For example, the product information server uploads the product information from the manufacturer. For example, the product information server uploads the product information from the manufacturer using a prescribed electronic product information upload form.

Preferably, but not necessarily, the product information system, using the product information server, translates the upload form to the product system user language.

For example, the product information comprises one or more of product basic information, product component information, product manufacture information, product manufacturer information, product comparison information, product untoward information, and the product contextual information. Preferably, but not necessarily, the product information comprises the product basic information.

Most preferably, but not necessarily, the product information comprises one or more of a product type, a product system user language, and a product system user location. The product information system is configured to use the product system user location to determine one or more product system user languages used in the product system user location. The product information system, using the product information server translates the product information into one or more of the product system user languages. Alternatively, or additionally, the product information system, using the product information server, uses the product system user languages to prepare a prescribed electronic product information upload form (as described in the previous paragraph) in the languages that are anticipated as most useful for the system user.

Alternatively, or additionally, the product information system obtains the product manufacturer information from the system applicant information submitted by the product manufacturer when registering as a system user. For example, the product information server provides the manufacturer with a form usable by the manufacturer to input the product manufacturer information. Alternatively, or additionally, the application server receives from the manufacturer an upload of the product manufacturer information.

For example, the product information server comprises a web-based server. For example, the product information server comprises an application server. For example, the system applicant provides system applicant information about itself as part of the login process. For example, the system applicant information comprises one or more of a system applicant name, a system applicant address, a system applicant company registry number, a system applicant tax reference number, a product type manufactured by the system applicant, a number of factories operated by the system applicant, an origin of a component used by the system applicant, a criminal record of the system applicant, a factory condition in a factory operated by the system applicant, and other system applicant information. For example, the login process further comprises payment, by the system applicant, using the server, of an applicable registration fee. Block 322 then transfers control to block 323.

In step 323, the product information system, using the product information server, creates a product passport for the product, the product passport comprising a unique alphanumeric code. At this point in time, the product passport comprises an “empty” product passport analogous to a blank passport form prior to addition of a human being's personal information and photograph to the blank passport form. Block 323 then transfers control to block 324.

In step 324, the product information system, using the product information server, sends the product passport to the manufacturer. For example, the product information server makes available to the manufacturer a download of the product passport comprising the unique alphanumeric code. Block 324 then transfers control to block 325.

In step 325, the product information system, using the product information server, receives a manufacturing code application update, the manufacturing code application update comprising an update advising the product information system that the manufacturer has applied the alphanumeric code to the product. Block 325 then transfers control to block 326.

In step 326, the product information system, using the product information server, provisionally associates the product passport with the individual product. For example, associating comprises applying the product passport's unique alphanumeric code to the product to which it is being associated. Block 326 then transfers control to block 327.

In step 327, the product information system, using the product information server, receives further product information regarding the product from the manufacturer. Optionally, this step comprises a sub-step, performed before the step of receiving the further product information from the manufacturer, of requesting, by the product information system, using the product information server, further product information regarding the product from the manufacturer.

For example, the further product information comprises one or more of the product's unique alphanumeric code, product basic information, product component information, product manufacture information, product manufacturer information, product comparison information, product untoward information, and the product contextual information. Preferably, but not necessarily, the further product information comprises the product's unique alphanumeric code, the product basic information, the product component information, the product manufacture information, the product manufacturer information, the product comparison information, the product untoward information, and the product contextual information.

Alternatively, or additionally, the product information system obtains the further product manufacturer information from the system applicant information submitted by the product manufacturer when registering as a system user. For example, the product information server provides the manufacturer with a form usable by the manufacturer to input the further product manufacturer information. Alternatively, or additionally, the application server receives from the manufacturer an upload of the further product manufacturer information.

For example, the product basic information comprises one or more of a product type, a product manufacturer name, a product manufacture date, a product manufacture time, a product manufacture location, a product component product passport's unique alphanumeric code, a product shipping date, a product shipping time, a product typical wholesale price, a product typical retail price, a product code, a product description, a product number, a product Universal Product Code (UPC), and an exact product specification. The product component product passport comprises a product passport of a component of the product. The product component comprises one or more of a component of the product, a product ingredient, a raw material used in creating the product, a chemical used in creating the product, and a product part.

The product information system is configured to use the product system user location to determine one or more product system user languages used in the product system user location. The product information system, using the product information server, translates the product information into one or more of the product system user languages. Alternatively, or additionally, the product information system, using the product information server, uses the product system user languages to prepare a prescribed electronic product information upload form for the system user in the languages that are anticipated as most useful for the system user.

For example, a product can be manufactured in China, where the product information server provides the manufacturer with product information and an upload form in Cantonese, the same product can be transported by an English shipping system, during which the product information server provides the shipper with product information and an upload form in English, and the same product can then be sold in Germany, where the product information server provides the retailer with product information and an upload form in German, and a product information request can be entered regarding the same product by a system user in Finland, where the product information server provides the requester with product information, an inquiry form, and a response in Finnish. It should be noted that it would not be remotely possible for a human, using pencil and paper, to hypothetically mimic this invention, since aside from requiring millions of computations per second, a hypothetical human attempting to mimic embodiments of the invention would necessarily need to be capable of fluently and instantaneously performing cross-translations in all human languages. Thus, embodiments of the invention are only achievable using a specialized computer, as disclosed elsewhere in this application.

For example, the product component information comprises one or more of product raw material information, product ingredient information, and product chemical information. For example, the product raw material information comprises one or more of a raw material type, a raw material quantity, a raw material source, a raw material performance, and other raw material information. For example, the product ingredient information comprises one or more of an ingredient type, an ingredient quantity, an ingredient source, an ingredient performance, and other ingredient information. For example, the product chemical information comprises one or more of a chemical type, a chemical quantity, a chemical source, a chemical performance, and other chemical information.

For example, the product manufacture information comprises one or more of a product manufacture skill level, a product manufacture wage level, a product manufacture machine, a product manufacturing process step duration, a representative product manufacture wastage, a representative product manufacture error level, regional product manufacture information, and other product manufacture information. For example, the regional product manufacture information comprises information for a region in which the product is manufactured regarding one or more of a representative wage, a worker safety standard, a worker health standard, a manufacturer environmental standard, and a manufacturer ethical standard.

For example, the product manufacturer information comprises information submitted by the product manufacturer as a system applicant when registering on the product information system. For example, the product manufacturer information comprises the system applicant information submitted by the manufacturer.

For example, the product comparison information comprises product information for a comparable product. For example, the product comparison information comprises product information for a comparable product previously registered on the system. For example, a third-party information source provides the product comparison information. For example, the product comparison information comprises one or more of comparable product raw material information, comparable product ingredient information, and comparable product chemical information. For example, the comparable product raw material information comprises one or more of a raw material type, a raw material quantity, a raw material source, a raw material performance, and other raw material information. For example, the comparable product ingredient information comprises one or more of an ingredient type, an ingredient quantity, an ingredient source, an ingredient performance, and other ingredient information. For example, the comparable product chemical information comprises one or more of a chemical type, a chemical quantity, a chemical source, a chemical performance, and other chemical information.

For example, the product contextual information comprises third-party information source data relevant to the product, including one or more of a regional labor rate in a region where the produce is manufactured, a review of the product by a third-party authority, an independent review of reliability of the product relative to comparable products, and the like.

The product information system can request further product information as many times as needed to evaluate the product. For example, in case of a disagreement about the wage paid by the manufacturer's factory, the product information server requests the manufacturer to verify all wage information regarding the factory in order to resolve the identified discrepancy. Block 327 then transfers control to block 328.

In step 328, the product information system, using the product information server, validates the received further product information. For example, the product information server validates the received further product information using artificial intelligence. Validation comprises critically reviewing the received further product information in preparation to do one or more of accept and reject the received further product information.

The validation step comprises checking for one or more of product information mis-entry by the manufacturer, fraud, and another discrepancy. For example, if the manufacturer states that the factory pays twice the prevailing wage, but product comparison information previously received from the manufacturer states that the factory pays below the prevailing wage, the validation process identifies the discrepancy.

For example, the product information server validates the received further product information by comparing the received further product information with comparable product information received from a system participant associated with the product. For example, the system participant associated with the product comprises one or more of a manufacturer associated with the product, a transporter associated with the product, a retailer associated with the product, an end user associated with the product, a disposer associated with the product, a comparable system user that is comparable with the manufacturer, and a third-party information source comprising product information relevant to validation of the received product information.

For example, if the product comprises a washing machine that is actually Finnish, but the received product information states that the product is German, the validation process identifies the discrepancy and requires the manufacturer to correct it. Alternatively, or additionally to not validating the product, the product information server requests further information from the manufacturer to facilitate further product validation. For example, in the case of the Finnish washing machine, the product information server requests the manufacturer to verify all product information regarding the product. Block 328 then transfers control to block 329.

In step 329, the product information system, using the product information server, decides whether to accept the received product information. If the product information server determines that agreement between the received product information and the product comparison information is sufficient, the product information server accepts the received product information. If the product information server determines that the agreement is not sufficient, the product information server rejects the received product information.

The product information server can decide to accept a portion of the received product information while rejecting a remaining portion of the received product information, in which case the method branches depending on which portion of the received product information is being addressed. If the product information server decides to accept the received product information, block 329 then transfers control to block 331. If the product information server decides to reject the received system applicant information, block 329 then transfers control to block 330.

In step 330, the product information system, using the product information server, rejects the product and then notifies the manufacturer of the rejection of the product by the product information system. Block 330 then terminates the process.

In step 331, the product information system, using the product information server, obtains third-party product information regarding the product from a trusted third-party information source.

For example, the product information system obtains third-party product information from a trusted third-party information source. Alternatively, or additionally, the third-party product information comprises product information that the product information system generates using a product passport for a comparable product that is one or more of related to the product and similar to the product. For example, the third-party product information comprises third-party product information regarding one or more of the manufacturer and the product. Preferably, but not necessarily, the third-party product information comprises third-party product information regarding both the manufacturer and the product. For example, the product comparison comprises information regarding an average regional wage in a region of manufacture where the system applicant's factory is located. For example, the third-party information source comprises one or more of a federal company registry, a federal tax registry, a state company registry and a state corporate tax registry. Block 331 then transfers control to block 332.

In step 332, the product information system, using the product information server, generates product comparison information usable to compare the product with a comparable product. For example, generating comprises one or more of obtaining and locating. For example, obtaining comprises obtaining from one or more of the trusted third-party source and a comparable system participant. For example, generating comprises locating product comparison information relating to the product and comprised in the product information system.

For example, the product comparison information comprises product information for a comparable product. For example, the product comparison information comprises product information for a comparable product previously registered on the system. For example, a third-party information source provides the product comparison information. Block 332 then transfers control to block 333.

In step 333, the product information system, using the product information server, overlays two or more of the product information, the third-party product information, and the product comparison information. Block 333 then transfers control to block 334.

In step 334, the product information system, using the product information server, validates the product. Validation comprises critically reviewing the product in preparation to do or more of accept the product and reject the product. For example, the product information server validates the product using artificial intelligence. Block 334 then transfers control to block 335.

In step 335, using the overlay, the product information system, using the product information server, makes a product decision. For example, the step of making the product decision comprises comparing two or more of the received product information, the third-party product information, and product comparison information.

The product decision comprises one or more of a final product acceptance, a final product rejection, and a provisional product rejection. The provisional product rejection comprises a request, by the system to the manufacturer, for further product information usable by the product information server to change the provisional product rejection to one or more of a final product acceptance and a final product rejection. Thus, if the product information system decides on a provisional product rejection, the system loops back to step 325 to request further information usable by the product information server to change the provisional product rejection to one or more of a final product acceptance and a final product rejection. The system can make such requests for further product information multiple times if the system deems this appropriate. If the product information system decides on a final product acceptance, block 335 then transfers control to block 336. If the product information system decides on a final product rejection, block 335 then transfers control to block 330.

In step 336, the product information system, using the product information server, accepts the product on the product information system. Block 336 then transfers control to block 337.

In step 337, the product information system, using the product information server, authenticates the product as a legitimate, known product on the product information system. Block 337 then transfers control to block 338.

In step 338, the product information system, using the product information server, notifies the manufacturer of the acceptance of the product on the product information system. Block 338 then transfers control to block 339.

In step 339, the product information system, using the product information server, associates the product passport comprising its own unique alphanumeric code with the individual product. For example, associating comprises applying the product passport's unique alphanumeric code to the product to which it is being associated.

For example, the product information server associates with the product's product passport one or more of the product information, the product's unique alphanumeric code, the third-party manufacturer information regarding the manufacturer, the third-party product information regarding the product, and the system applicant information previously submitted by the manufacturer. Preferably, but not necessarily, the product information server associates with the product's product passport the product information, the product's unique alphanumeric code, the third-party manufacturer information regarding the manufacturer, the third-party product information regarding the product, product contextual information, and the system applicant information previously submitted by the manufacturer. For example, the product passport comprises a passport file. Block 339 then transfers control to block 340.

In step 340, the product information system, using the product information server, populates the product information into the product passport, thereby completing an initial product passport. Block 340 then transfers control to block 342.

In step 342, the product information system, using the product information server, stores the product passport. For example, the product information system stores the product passport in the database. Block 342 then terminates the process.

Once a product has been accepted into the system as set forth in FIG. 3, other system users can access product information regarding the product. Preferably, but not necessarily, once the product has been accepted into the system, all other system users can access the product information regarding the product.

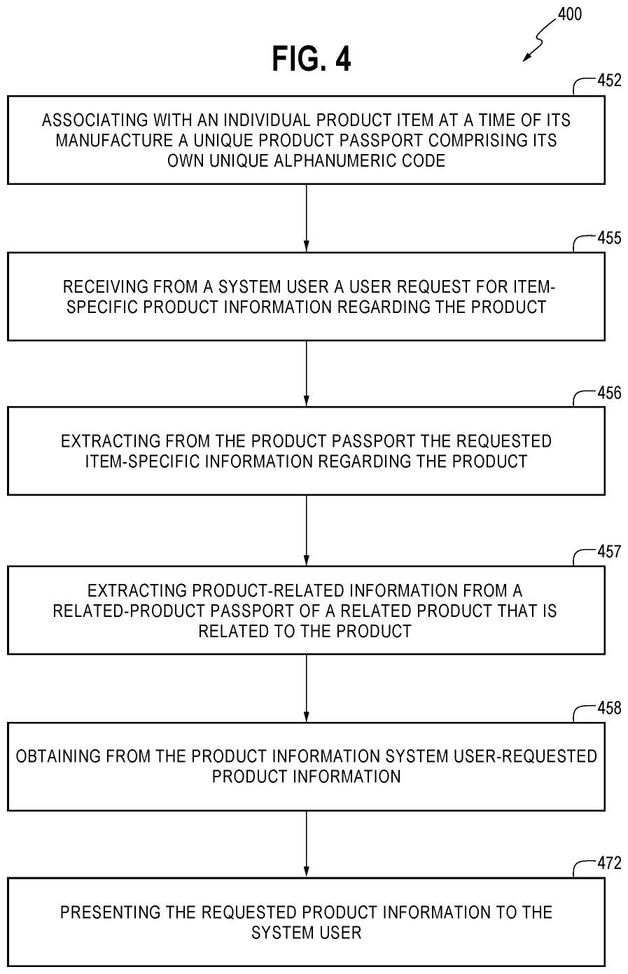

FIG. 4 is a flow chart of a method 400 for using a product passport and a product information system for providing item-specific product information. More specifically, FIG. 4 is a flow chart of a method 400, using a product passport and a product information system, for providing item-specific product information to a system user in response to a system user request.

The order of the steps in the method 400 is not constrained to that shown in FIG. 4 or described in the following discussion. Several of the steps could occur in a different order without affecting the final result.

In step 452, the product information system, using the product information server, associates with an individual product item at a time of its manufacture a unique product passport comprising its own unique alphanumeric code. Block 452 then transfers control to block 455.

In step 455, the product information system, using the product information server, receives from a system user a user request for item-specific product information regarding the product.

For example, the user request further comprises one or more of a user language and a user location. Preferably, but not necessarily, the product information system, using the product information server, uses the user location to determine one or more user languages used in the user location. Block 455 then transfers control to block 456.

In step 456, the product information system, using the product information server, extracts from the product passport the requested item-specific information regarding the product. Block 456 then transfers control to block 457.

In step 457, the product information system, using the product information server, extracts product-related information from a related-product passport of a related product that is related to the product. For example, the product information system uses the product-related information to compare the product to the related product for validation of the item-specific information relating to the product item. Block 457 then transfers control to block 458.

In step 458, the product information system, using the product information server, obtains from the product information system user-requested product information. For example, the application server sends a request fulfillment message to the product information server comprising requested product information. For example, the application server sends a request fulfillment message to the product information server comprising publicly available requested product information. For example, in the case where the retailer forwards the user request, the product information server sends the retailed a request fulfillment message including the requested information. For example, the retailer displays the request fulfillment message for viewing by the system user. For example, the retailer displays the request fulfillment message for viewing by the system user using the system user device. For example, the product information comprises one or more of the product's unique alphanumeric code, product basic information, product component information, product manufacture information, product manufacturer information, product comparison information, product untoward information, and product contextual information. Preferably, but not necessarily, the product information comprises the product's unique alphanumeric code, the product basic information, the product component information, the product manufacture information, the product manufacturer information, the product comparison information, the product untoward information, and the product contextual information.

For example, the product basic information comprises one or more of a product type, a product manufacturer name, a product manufacture date, a product manufacture time, a product manufacture location, a product component product passport's unique alphanumeric code, a product shipping date, a product shipping time, a product typical wholesale price, a product typical retail price, a product code, a product description, a product number, a product Universal Product Code (UPC), and an exact product specification.

For example, the product component information comprises one or more of product raw material information, product ingredient information, and product chemical information. For example, the product raw material information comprises one or more of a raw material type, a raw material quantity, a raw material source, a raw material performance, and other raw material information. For example, the product ingredient information comprises one or more of an ingredient type, an ingredient quantity, an ingredient source, an ingredient performance, and other ingredient information. For example, the product chemical information comprises one or more of a chemical type, a chemical quantity, a chemical source, a chemical performance, and other chemical information.

For example, the product manufacture information comprises one or more of a product manufacture skill level, a product manufacture wage level, a product manufacture machine, a product manufacturing process step duration, a representative product manufacture wastage, a representative product manufacture error level, regional product manufacture information, and other product manufacture information. For example, the regional product manufacture information comprises information for a region in which the product is manufactured regarding one or more of a representative wage, a worker safety standard, a worker health standard, a manufacturer environmental standard, and a manufacturer ethical standard.

For example, the product comparison information comprises information the product information server has received from a system participant associated with the product. That is, the product comparison information comprises information the product information server has received from one or more of a manufacturer associated with the product, a transporter associated with the product, a retailer associated with the product, an end user associated with the product, a disposer associated with the product, a system participant associated with a comparable product that is comparable with the product, and a third-party information source comprising product information relevant to validation of the received product information. For example, the system participant comprises the manufacturer. For example, the product comparison information is usable by the product information system to perform the validation by independently validating the received product information.

For example, the product contextual information comprises third-party information source information relevant to the product, including one or more of a regional labor rate in a region where the product is manufactured, a review of the product by a third-party authority, an independent review of reliability of the product relative to comparable products, and the like.

Optionally, the method comprises a further step of receiving, by the product information server, from the system user, a request for additional product information regarding the product item. The product information server may grant access to the system user to acquire access to any available additional product information, either for free or for a fee. In embodiments, where information requiring a payment is requested, the end user may be charged by the application server of the product information server (if registered for example) or by the online retailer. In particular, the end user may have an existing account with online retailer which can be used to deduct the relevant charges. In embodiments, the online retailer may have obtained the product information that is available about the product without charge from the product information system in advance, whereas the product information requiring payment is requested from the product information server in real time. Alternatively, the online retailer may also have obtained the chargeable information from information distributor in advance, so that request and response are optional. Block 458 then transfers control to block 472.

In step 472, the product information system, using the product information server, presents the requested product information to the system user. For example, the product information system presents the requested product information to the system user on a website. For example, the product information system presents the requested product information to the system user on the website of a retailer. For example, the retailer comprises one or more of a direct sale manufacturer, a hospital, a surgery, a wholesaler, an end shop, and an online retailer.

Optionally, the method further comprises an additional step, performed after the obtaining step and before the presenting step, of translating, by the product information system, using the product information server, the requested product information into the user language. Block 472 then terminates the process.

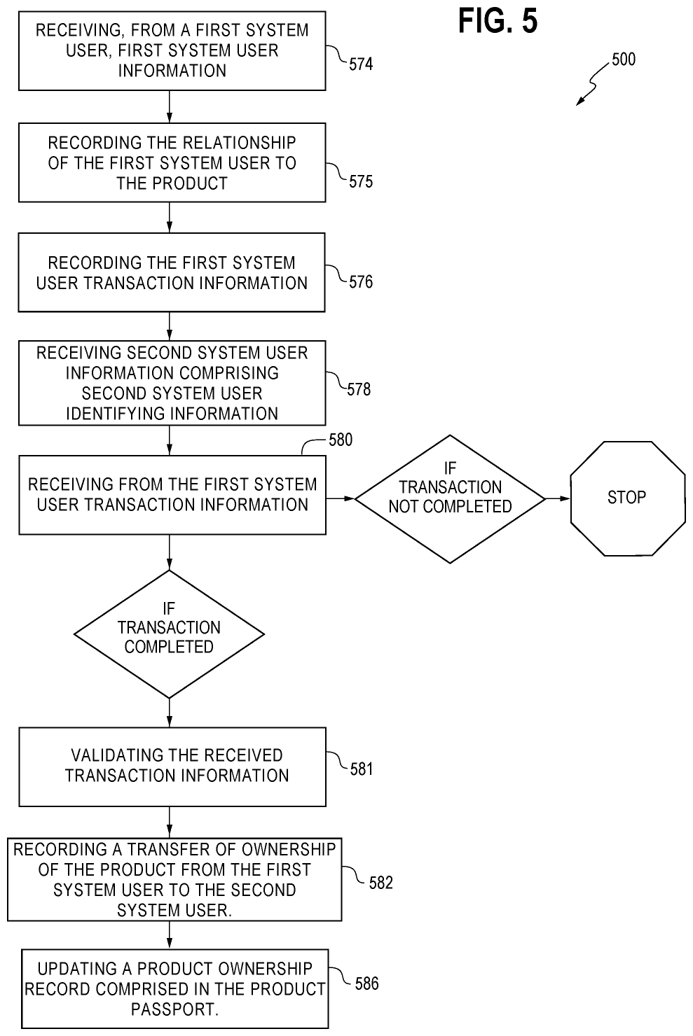

FIG. 5 is a flow chart of a method 500 for using a product passport and a product information system for providing item-specific product information. More specifically, FIG. 5 is a flow chart of a method 500, using a product passport and a product information system, for recording a product transaction involving the product. For example, the product transaction comprises one or more of a sale of the product, a purchase of the product, and a lease of the product. For example, the product transaction comprises a change of ownership of the product, as with one or more of a sale of the product and a purchase of the product. For example, the product transaction comprises a change of possession of the product, as with one or more of a sale of the product, a purchase of the product, and a lease of the product.

The order of the steps in the method 500 is not constrained to that shown in FIG. 5 or described in the following discussion. Several of the steps could occur in a different order without affecting the final result.

In step 574, the product information system, using the product information server, receives, from a first system user, first system user information. The first system user information comprises first system user identifying information identifying the first system user. The first system user information further comprises first system user product relationship information regarding a relationship of the first system user to the product. The first system user information further comprises first system user transaction information identifying a desired transaction of the first system user with a product, the desired transaction intended to transfer the product from the first system user to a second system user. The first system user transaction information further comprising the product's unique alphanumeric code. For example, the first system user comprises a retailer of the product. For example, the product comprises a television.

For example, the product information system does not require the second system user to be registered as an authorized system user.

The first system user identifying information comprises one or more of a first system user credential identifying the first system user of the product as an authorized system user, the product's unique alphanumeric code, a location of the first system user, the first system user's name, the first system user's address, the first system user's email address, the first system user's telephone number, the first system user's facsimile number, the first system user's social media handle, and other information regarding the first system user. The first system user identifying information further comprises product relationship information regarding a relationship of the first system user to the product. For example, the first system user comprises a retailer of the product. For example, the retailer comprises one or more of a direct sale manufacturer, a hospital, a surgery, a wholesaler, an end shop, and an online retailer.

For example, the transaction comprises one or more of a past transaction, an ongoing transaction, and a desired transaction. For example, the first system user comprises a retailer. For example, the first system user transaction comprises a sale the retailer desires to make of the product to a consumer.

For example, the transaction comprises one or more of a logistics transaction, a product integration transaction, a product repair, a product sale, a product lease, a product loan, a product disposal, and another transaction. For example, the logistics transaction comprises transportation of the product. For example, the product integration transaction comprises combining a plurality of products to make one or more of a bundle of products and a new product. For example, the product sale comprises a product sale to one or more of a retailer, a wholesaler, an end user, and a disposer. For example, the product disposer performs one or more of product consumption, recycling, disposal, and destruction. Block 574 then transfers control to block 575.

In step 575, the product information system, using the product information server, records the relationship of the first system user to the product. For example, the first system user comprises a seller. The relationship comprises one or more of a possession, a rental, a lease, a use, an integration of the product into a second product, a consumption of the product, and a destruction of the product. For example, the possession comprises possession pursuant to transportation of the product. For example, the possession comprises possession by a transporter pursuant to transportation of the product. For example, the possession comprises possession by a transporter pursuant to transportation of the product from a manufacturer to a retailer. For example, the possession comprises possession by a transporter pursuant to transportation of the product from a retailer to an end user. For example, the transaction comprises a purchase by a medical body for use of the product in a prescription for a patient. For example, the transaction comprises an acquisition through financing secured against the purchase of the product. For example, the integration can comprise replacement of a spare part of the second product. Block 575 then transfers control to block 576.

In step 576, the product information system, using the product information server, records the first system user transaction information. Block 576 then transfers control to block 578.

In step 578, the product information system, using the product information server, receives second system user information comprising second system user identifying information. The second system user information comprises second system user identifying information identifying the second system user. The second system user information further comprises second system user product relationship information regarding a relationship of the second system user to the product. The second system user information further indicating that the second system user is completing the desired transaction. The second system user information further comprises the product's unique alphanumeric code. For example, the second system user comprises a purchaser of the product.

The second system user identifying information comprises one or more of a second system user credential identifying the second system user of the product as an authorized system user, the product's unique alphanumeric code, a location of the second system user, the second system user's name, the second system user's address, the second system user's email address, the second system user's telephone number, the second system user's facsimile number, the second system user's social media handle, and other information regarding the second system user. The second system user identifying information further comprises product relationship information regarding a relationship of the second system user to the product. For example, the second system user comprises an end user of the product. For example, the second system user purchases the product from the first system user. Block 578 then transfers control to block 580.

In step 580, the product information system, using the product information server, receives from the first system user transaction information. Alternatively, or additionally, the product information system, using the product information server, receives from the second system user transaction information. For example, the transaction information comprises a transaction confirmation confirming one or more of completion and non-completion of the desired transaction.

Optionally, the product information server requests from the second system user a transaction confirmation confirming one or more of completion and non-completion of the desired transaction. For example, the product information server requests from the second system user a sale confirmation confirming one or more of completion and non-completion of the desired sale of the product from the first system user to the second system user. Alternatively, or additionally, the first system user identifying information comprises the transaction confirmation. Optionally, the product information server requests from the second system user second system user identifying information including one or more of a second system user credential identifying the second system user as an authorized system user, the product's unique alphanumeric code, a date of sale, a time of sale, a price of sale, a location of sale, a product code, the second system user's name, the second system user's address, the second system user's email address, the second system user's telephone number, the second system user's facsimile number, the second system user's social media handle, a product warranty start date, a product warranty termination date, a product warranty duration, a product warranty cover term, a product delivery date, and other information regarding the second system user.

Optionally, the product information server requests from the first system user a transaction confirmation confirming one or more of completion and non-completion of the desired transaction. For example, the product information server requests from the first system user a sale confirmation confirming one or more of completion and non-completion of the desired sale of the product from the first system user to the second system user. Alternatively, or additionally, the first system user identifying information comprises the transaction confirmation. Optionally, the product information server requests from the first system user first system user identifying information including one or more of a first system user credential identifying the second system user as an authorized system user, the product's unique alphanumeric code, a date of sale, a time of sale, a price of sale, a location of sale, a product code, the first system user's name, the first system user's address, the first system user's email address, the first system user's telephone number, the first system user's facsimile number, the first system user's social media handle, a product warranty start date, a product warranty termination date, a product warranty duration, a product warranty cover term, a product delivery date, and other information regarding the first system user.

The product information server records a change of ownership of the product from the first system user to the second system user. The product information server updates a product ownership record comprised in the product passport. If the transaction is not completed, block 580 terminates the process. If the transaction is completed, block 580 then transfers control to block 581.

In step 581, the product information system, using the product information server, validates the received transaction information. For example, the product information server validates the received transaction information using artificial intelligence. For example, the product information server validates the received transaction information by comparing the received transaction information with product comparison information. The product comparison information comprises product information that the product information server has received from a system participant associated with the product. That is, the product comparison information comprises product information that the product information server has received from one or more of a manufacturer associated with the product, a transporter associated with the product, a retailer associated with the product, an end user associated with the product, a disposer associated with the product, a system participant associated with a comparable product that is comparable with the product, and a third-party information source comprising product information relevant to validation of the received product information. For example, the system participant comprises the manufacturer. For example, the product comparison information is usable by the product information system to perform the validation by independently validating the received product information. If the product information server determines that agreement between the received product information and the product comparison information is sufficient, the product information server accepts the received product information. If the product information server determines that the agreement is not sufficient, the product information server rejects the received product information.

The validation step comprises checking for one or more of product information entry by the manufacturer, location of the transaction, the transaction price, lack of fraud in the transaction, a proper product supply chain, correctness of a transaction, a correct first system user, a correct second system user, release of the finance charge to which the product is subject, transaction authorization for the transaction of the first system user, transaction authorization for the transaction of the second system user, and another validation criterion. Preferably, but not necessarily, the validation step comprises checking for the product information entry by the manufacturer, the location of the transaction, the transaction price, the lack of fraud in the transaction, the proper product supply chain, correctness of a transaction, the correct first system user, the correct second system user, the release of the finance charge to which the product is subject, the transaction authorization for the transaction of the first system user, and the transaction authorization for the transaction of the second system user. For example, in the case of a purchase of the product, the product information server validates the product information entry by the manufacturer, the location of the purchase, the purchase price, the lack of fraud in the purchase, the proper product supply chain, the correctness of the purchase, the correct second system user, the correct first system user, the release of the finance charge to which the product is subject, and the purchase authorization for the purchase of the purchasing system user.

For example, the system prohibits the purchase authorization because of one or more of the first system user's age, the first system user's lack of a required permit, the first system user being subject to a sanction, the first system user lacking a needed license for purchase of a restricted product, and another prohibition reason. For example, the system prohibits the transaction authorization because of one or more of the second system user's age, the second system user's lack of a required permit, the second system user being subject to a sanction, the second system user lacking a needed license for purchase of a restricted product, and another prohibition reason.

For example, the system prohibits the transaction authorization because of one or more of the first system user's age, the first system user's lack of a required permit, the first system user being subject to a sanction, the first system user lacking a needed license for purchase of a restricted product, and another prohibition reason. For example, the incorrect second system user comprises a prohibited second system user. For example, the system prohibits the transaction authorization because of one or more of the second system user's age, the second system user's lack of a required permit, the second system user being subject to a sanction, the second system user lacking a needed license for purchase of a restricted product, and another prohibition reason. If the product information server decides to reject the received purchase information, the process stops. If the product information server decides to accept the received purchase information, block 581 then transfers control to block 582.

In step 582, the product information system, using the product information server, records a transfer of ownership of the product from the first system user to the second system user. Alternatively, or additionally, the product information system uses the application server to record the change of ownership. For example, the change of ownership comprises a transfer of ownership. The product information server updates a product ownership record comprised in the product passport. For example, where a second system user comprises a transporter and the second system user accepts the product only for transport, the change of possession does not transfer ownership.

Optionally, the step of recording the change of ownership comprises a sub-step of receiving product comparison information from a system participant associated with the product.

Optionally, the step of recording the change of ownership further comprises an additional sub-step, performed after the sub-step of receiving the product comparison information, of comparing the received transaction information with the product comparison information.

Optionally, the step of recording the change of ownership further comprises an additional sub-step, performed after the comparing sub-step, of determining if agreement between the received transaction information and the product comparison information is sufficient. Block 582 then transfers control to block 586.

In step 586, the product information system, using the product information server, updates a product possession record comprised in the product passport. For example, the step of updating the product possession record reflects the transaction. For example, if the transaction comprises a sale of a consumer good from a retailer to a consumer, the step of updating comprises recording the consumer as the new possessor and owner of the consumer good.

Updating comprises one or more of adding new product ownership information, supplementing existing product ownership information with new product ownership information, and replacing the existing product ownership information with new product ownership information. The product ownership information comprises one or more of the product's unique alphanumeric code, a date of sale, a time of sale, a price of sale, a location of sale, a product code, a financing arrangement used in the sale, a medical insurance funding arrangement used in the sale, the owner's name, the owner's address, the owner's email address, the owner's telephone number, the owner's facsimile number, the owner's social media handle, and other information regarding the owner. For example, the medical insurance comprises one or more of government medical insurance and private medical insurance.

For example, the step of updating the product passport reflects the transaction. For example, if the transaction comprises a sale of a consumer good from a retailer to a consumer, the step of updating comprises recording in the product passport the consumer as the new possessor and owner of the consumer good. Block 586 then terminates the process.

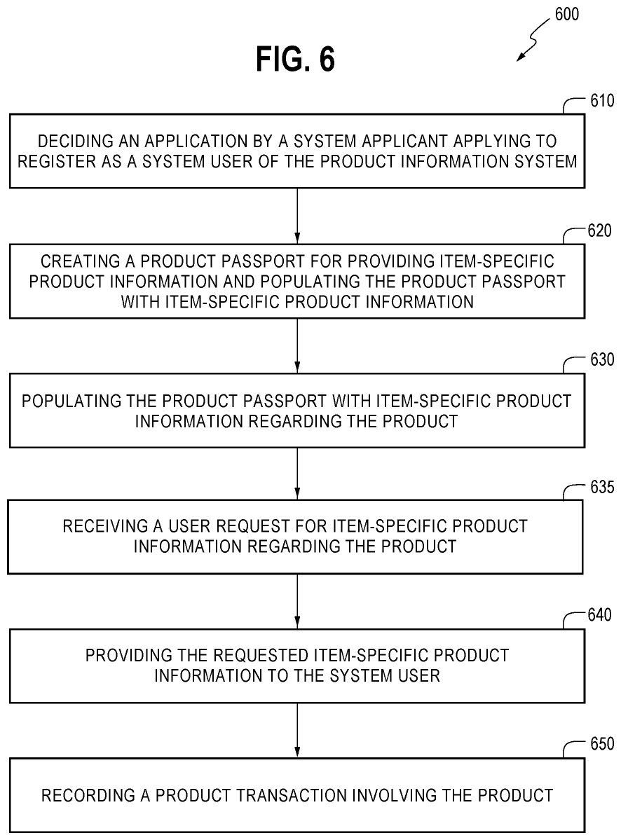

FIG. 6 is a flow chart of a method 600 for using a product passport and a product information system for providing item-specific product information. More specifically, FIG. 6 is a flow chart of a method 600, using a product passport for providing item-specific product information, and using a product information system, for deciding an application by a system applicant applying to register as a system user of the product information system, for creating a product passport, for populating the product passport with item-specific product information, for providing item-specific product information to a system user in response to a system user request, and for recording a transaction involving the product. Step 610 of FIG. 6 corresponds to FIG. 2. Steps 620 and 630 of FIG. 6 correspond to FIG. 3. Steps 635 and 640 of FIG. 6 correspond to FIG. 4. Step 650 of FIG. 6 corresponds to FIG. 5.

The order of the steps in the method 600 is not constrained to that shown in FIG. 6 or described in the following discussion. Several of the steps could occur in a different order without affecting the final result.

In step 610, the product information system, using a product information server, decides an application by a system applicant applying to register as a system user of the product information system. Block 610 then transfers control to block 620.

In step 620, the product information system, using the product information server, creates a product passport for providing item-specific product information and populates the product passport with item-specific product information. Block 620 then transfers control to block 630.

In step 630, the product information system, using the product information server, populates the product passport with item-specific product information regarding the product. Block 630 then transfers control to block 635.

In step 635, the product information system, using the product information server, receives a user request for item-specific product information regarding the product. Block 635 then transfers control to block 640.

In step 640, the product information system, using the product information server, provides the requested item-specific product information to the system user. Block 640 then transfers control to block 650.

In step 650, the product information system, using the product information server, records a product transaction involving the product. Block 650 then terminates the process.

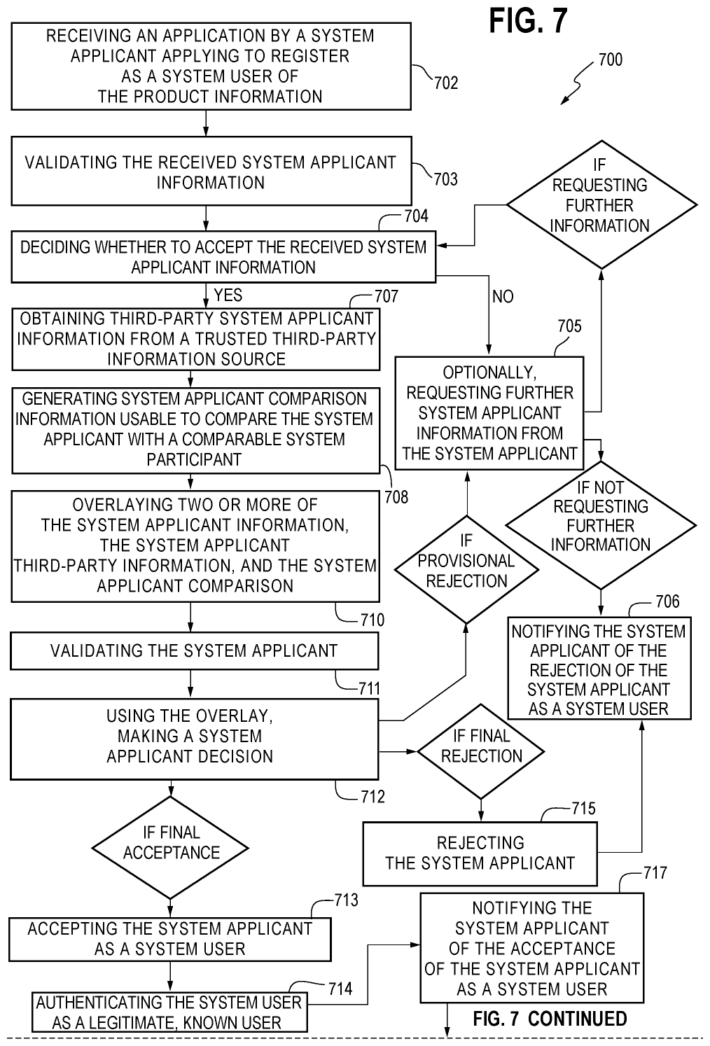

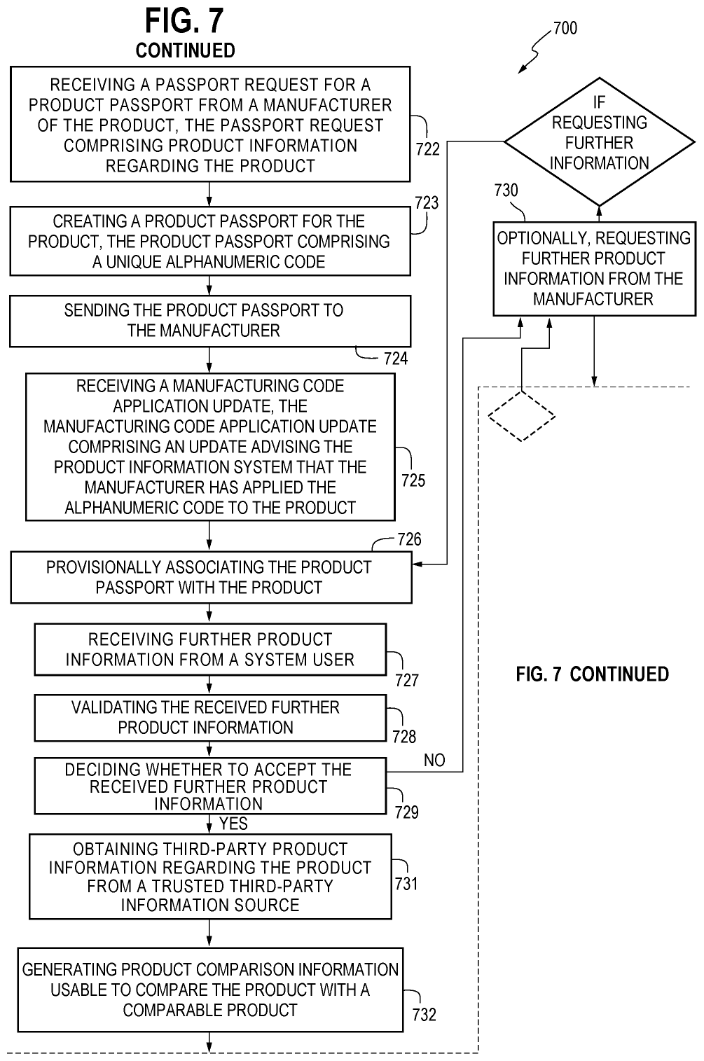

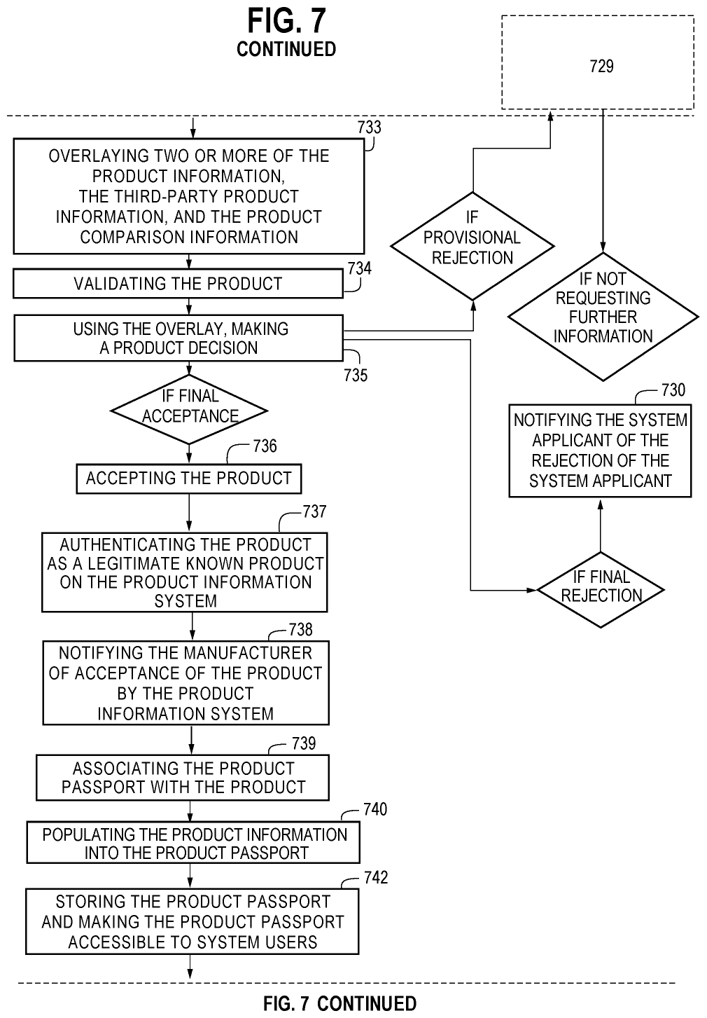

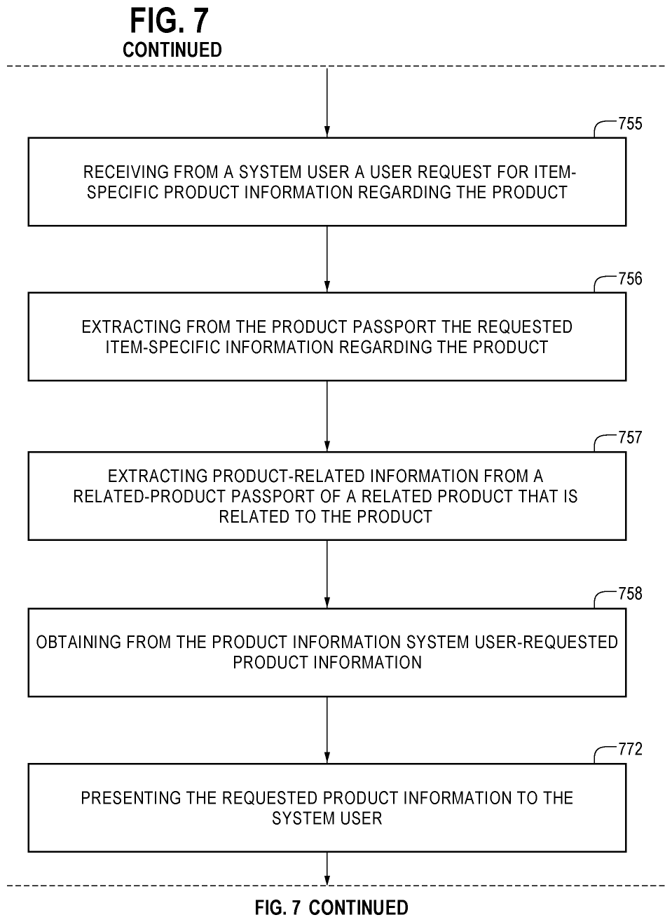

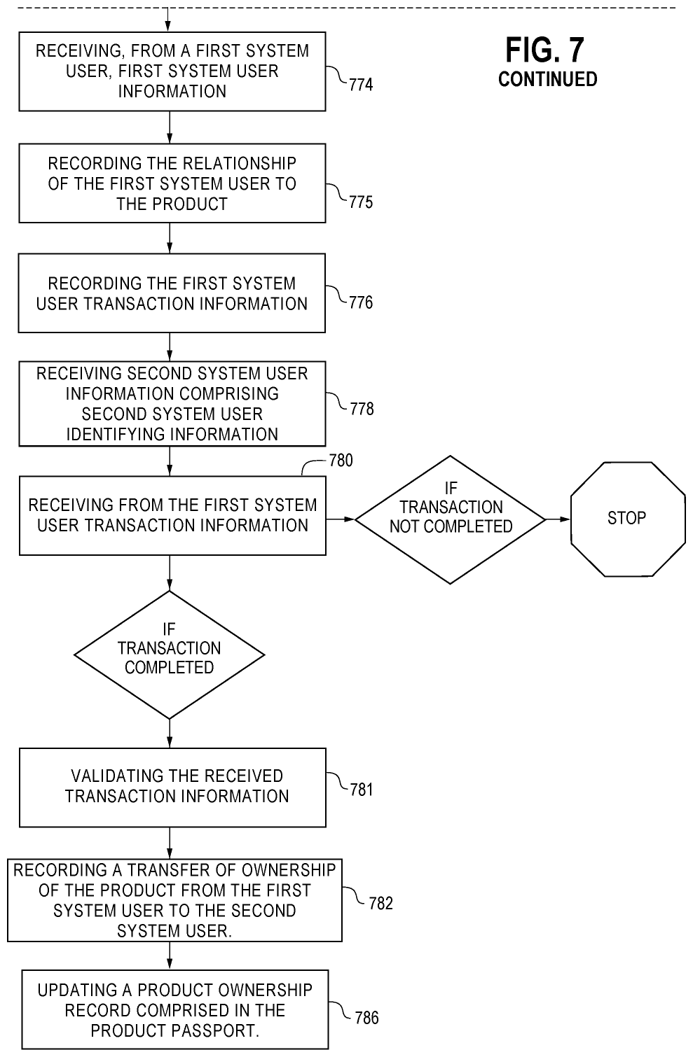

FIG. 7 is a flow chart of a method 700 for using a product passport and a product information system for providing item-specific product information. More specifically, FIG. 7 is a flow chart of a method 700, using a product passport for providing item-specific product information, and using a product information system, for deciding an application by a system applicant applying to register as a system user of the product information system, for creating a product passport, for populating the product passport with item-specific product information, for providing item-specific product information to a system user in response to a system user request, and for providing item-specific product information in response to a retail sale of the product. FIG. 7 is a more detailed version of FIG. 6, providing detail on steps carried out in each of the steps 610 to 640 in FIG. 6. Step 610 in FIG. 6, which corresponds to FIG. 2 is set forth as steps 702 to 718 in FIG. 7. Steps 620 and 630 in FIG. 6, which correspond to FIG. 3, are set forth as steps 722 to 742 in FIG. 7. Steps 635 and 640 in FIG. 6, which correspond to FIG. 4, are set forth as steps 755 to 772 in FIG. 7. Step 650 in FIG. 6, which corresponds to FIG. 5, is set forth as steps 774 to 786 in FIG. 7.

The order of the steps in the method 700 is not constrained to that shown in FIG. 7 or described in the following discussion. Several of the steps could occur in a different order without affecting the final result.

In step 702, the product information system, using a product information server, receives system applicant information from a system applicant applying to register as a system user of the product information system. For example, the system applicant comprises one or more of a manufacturer, a transporter, a retailer, an end user, a disposer, and a third-party information source. For example, the application comprises system applicant information. For example, the system applicant information comprises one or more of system applicant basic information, and other system applicant information.

Preferably, but not necessarily, the step of receiving the system applicant information comprises providing the system applicant, by the product information system, using the product information server, with a transmission method for transmitting to the product information server the system applicant information. Preferably, but not necessarily, the transmission method comprises uploading the product information from the system applicant using a prescribed electronic product information upload form. Preferably, but not necessarily, the system applicant information comprises one or more of a system applicant language and a system applicant location. Preferably, but not necessarily, the product information system, using the product information server, uses the system applicant location to determine one or more system applicant languages used in the system applicant location. Preferably, but not necessarily, the product information system, using the product information server, translates the product information into the system applicant language. Preferably, but not necessarily, the product information system, using the product information server, translates the upload form to the system applicant language.

For example, the system applicant basic information comprises one or more of a system applicant name, a system applicant address, a system applicant email address, a system applicant telephone number, a system applicant's facsimile number, a system applicant social media handle, a system applicant company registry number, a system applicant tax reference number, a product type manufactured by the system applicant, a number of factories operated by the system applicant, an origin of a component used by the system applicant, a criminal record of the system applicant, a factory condition in a factory operated by the system applicant, and other information regarding the system applicant.

For example, the system applicant comprises a third-party information source. For example, the system applicant provides system applicant information about itself as part of the login process. For example, the system applicant information comprises one or more of a system applicant name, a system applicant address, a system applicant email address, a system applicant telephone number, a system applicant's facsimile number, a system applicant social media handle, a system applicant company registry number, a system applicant tax reference number, a product type manufactured by the system applicant, a number of factories operated by the system applicant, an origin of a component used by the system applicant, a criminal record of the system applicant, a factory condition in a factory operated by the system applicant, and other information regarding the system applicant. For example, the login process further comprises payment, by the system applicant, using the server, of an applicable registration fee. Block 702 then transfers control to block 703.

In step 703, the product information system, using the product information server, validates the received system applicant information. For example, the product information server validates the received system applicant information using artificial intelligence. Validation comprises critically reviewing the received system applicant information in preparation to do one or more of accept the received system applicant information and reject the received system applicant information.

The validation step comprises checking for one or more of system applicant information mis-entry by the system applicant, fraud, and another discrepancy. For example, if the system applicant states that the factory pays twice the prevailing wage, but the system applicant comparison information states that the factory pays below the prevailing wage, the validation process identifies the discrepancy. Block 703 then transfers control to block 704.

In step 704, the product information system, using the product information server, decides whether to accept the received system applicant information. If the product information server determines that agreement between the received system applicant information and the system applicant comparison information is sufficient, the product information server accepts the received system applicant information. If the product information server determines that the agreement is not sufficient, the product information server rejects the received system applicant information.

The product information server can decide to accept a portion of the received system applicant information while rejecting a remaining portion of the received system applicant information, in which case the method branches depending on which portion of the received system applicant information is being addressed. If the product information server decides to accept the received system applicant information, block 704 then transfers control to block 707. If the product information server decides to reject the received system applicant information, block 704 then transfers control to block 705.

In step 705, optionally, the product information system, using the product information server, requests further system applicant information from the system applicant. For example, in the case discussed above regarding step 704 of the disagreement about the wage paid by the system applicant's factory, the product information server requests the system applicant to verify all wage information regarding the factory in order to resolve the identified discrepancy. Optionally, the product information server then receives the requested further system applicant information from the system applicant. Optionally, the product information server validates the received further system applicant information. Validation comprises critically reviewing the received further system applicant information in preparation to do one or more of accept the received further system applicant information and reject the received further system applicant information. For example, the product information server validates the received further system applicant information using artificial intelligence.

The validation step again comprises checking for one or more of system applicant information mis-entry by the system applicant, fraud, and another discrepancy. For example, if the system applicant states that the factory pays twice the prevailing wage, but the system applicant comparison information states that the factory pays below the prevailing wage, the validation process identifies the discrepancy.

The product information system can request further system applicant information as many times as needed to evaluate a system applicant's application. If the product information server requests further system applicant information, the process loops back to block 704 and the product information server decides whether to accept the received further system applicant information. If the product information server does not request further system applicant information, the process continues to block 706.

In step 706, the product information system, using the product information server, rejects the system applicant and then notifies the system applicant of the rejection of the system applicant by the product information system. Block 706 then terminates the process.

In step 707, the product information system, using the product information server, obtains third-party system applicant information from a trusted third-party information source. The third-party system applicant information comprises one or more of third-party applicant information regarding the system applicant and system applicant comparison information relevant to evaluation of the application of the system applicant. For example, system applicant comparison information comprises information regarding an average regional wage in a region of manufacture where the system applicant's factory is located. For example, the third-party information source comprises one or more of a federal company registry, a federal tax registry, a state company registry and a state corporate tax registry. Block 707 then transfers control to block 708.

In step 708, the product information system, using the product information server, generates system applicant comparison information usable to compare the system applicant with a comparable system participant. For example, generating comprises one or more of obtaining and locating. For example, obtaining comprises obtaining from one or more of the trusted third-party source and the comparable system participant. For example, generating comprises locating system applicant comparison information from system participant information relating to the comparable system applicant and comprised in the product information system.

For example, the product comparison information comprises product information for a comparable product. For example, the product comparison information comprises product information for a comparable product previously registered on the system. For example, a third-party information source provides the product comparison information.

For example, the comparable system participant comprises a system participant that shares with the system applicant one or more of a system applicant characteristic role, a system applicant corporate status, a system applicant corporate ownership, a system applicant physical location, a system applicant product type, a system applicant service type, a system applicant employee number, a system applicant revenue, a system applicant comparable product, a system applicant comparable service, a system applicant regulator standard compliance certification, a system applicant market, a system applicant licensed market, a system applicant language spoken, a system applicant sanction status, a system applicant financial rating, a system applicant product performance, a system applicant independent product rating, a system applicant service performance, a system applicant independent service rating, a system applicant product price, a system applicant service price, a system applicant corporate status, a system applicant ethical corporate status, a system applicant legal compliance record, a system applicant creditworthiness rating, and another comparable system applicant characteristic.

For example, the system applicant characteristic role comprises one or more of a grower, a collector, a harvester of materials, an extractor of materials, a manufacturer, an integrator of other manufactured products to make one or more of a bundle of products and a new product, a transporter, a repairer, a retailer, a wholesaler, an end user, and a disposer. For example, the system applicant corporate ownership is usable to monitor compliance with a sanction against one or more of the system applicant and the comparable system user. For example, one or more of the system applicant service price and the system applicant product price comprises a price range. For example, the system applicant corporate status comprises one or more of a private corporation, a public corporation, a public benefit B corporation, a C corporation, a non-profit corporation, an S corporation a limited liability (LLC) corporation, a public limited company (PLC) corporation, and another type of corporation. For example, the system applicant ethical corporate status varies according to a system applicant definition but may comprise one or more of a non-profit corporation and a public benefit B corporation.

For example, the comparable system participant comprises one or more of a manufacturer associated with the system applicant, a transporter associated with the system applicant, a retailer associated with the system applicant, an end user associated with the system applicant, a disposer associated with the system applicant, a comparable system user that is comparable with the system applicant, and a third-party information source comprising system applicant information relevant to validation of the received system applicant information. For example, the system applicant comprises a manufacturer, and the comparable system participant comprises a manufacturer. For example, the system applicant information is usable by the product information system to perform the validation by independently validating the received system applicant information. Block 708 then transfers control to block 710.

In step 710, the product information system, using the product information server, overlays two or more of the system applicant information, the system applicant third-party information, and the system applicant comparison information. Block 710 then transfers control to block 711.

In step 711, the product information system, using the product information server, validates the system applicant. Validation comprises critically reviewing the received system applicant in preparation to do or more of accept the system applicant and reject the system applicant. For example, the product information server validates the system applicant using artificial intelligence. Block 711 then transfers control to block 712.

In step 712, using the overlay, the product information system, using the product information server, makes a system applicant decision. For example, the step of making the system applicant decision comprises comparing two or more of the received system applicant information, the third-party system applicant information, and system applicant comparison information received from a comparable system participant.

The system applicant decision comprises one or more of a final system applicant acceptance, a final system applicant rejection, and a provisional system applicant rejection of the system applicant. The provisional system applicant rejection comprises a request, by the system to the system applicant for further system applicant information usable by the product information server to change the provisional system applicant rejection to one or more of a final system applicant acceptance and a final system applicant rejection. Thus, if the product information system decides on a provisional system applicant rejection, the system loops back to step 705 to request further information usable by the product information server to change the provisional system applicant rejection to one or more of a final system applicant acceptance and a final system applicant rejection. The system can make such requests for further system applicant information multiple times if the system deems this appropriate. If the product information system decides on a final system applicant acceptance, thereby accepting the system applicant as a system user, block 712 then transfers control to block 713. If the product information system decides on a final system applicant rejection, block 712 then transfers control to block 715.

In step 713, the product information system, using the product information server, accepts the system applicant as a system user. Block 713 then transfers control to block 714.

In step 714, the product information system, using the product information server, authenticates the system user as a legitimate, known user of the product information system. Block 714 then transfers control to block 717.

In step 715, the product information system, using the product information server, rejects the system applicant. Block 715 then transfers control to block 716.

In step 716, the product information system, using the product information server, notifies the system applicant of the rejection of the system applicant as a system user. Block 716 then terminates the process.

In step 717, the product information system, using the product information server, notifies the system applicant of the acceptance of the system applicant as a system user. Previously submitted system applicant information can now be alternatively referred to as system user information. Using the acceptance, through a system user device, the system user can do one or more of access and utilize the product information system in a manner which is consistent with the nature of their registration. Block 717 then transfers control to block 722.

The method further comprises an optional additional step, performed after the populating step, of, using the product information system, using the product information server, creating an auditable trail of one or more of product ownership and product location. This method is set forth in more detail in FIG. 8 and in the associated independent claim.

In step 722, the product information system, using the product information server, receives a passport request regarding a product from a system user, the passport request comprising product information regarding the product. Preferably, but not necessarily, the product information comprises one or more of a product type, a product system user language, and a product system user location. Preferably, but not necessarily, the product information system, using the product information server, uses the product system user location to determine one or more product system user languages used in the product system user location.

For example, the system user comprises one or more of a manufacturer associated with the product, a transporter associated with the product, a retailer associated with the product, an end user associated with the product, and a disposer associated with the product. Most commonly, but not necessarily, the system user comprises the manufacturer of the product. To simplify the description, while any system user associated with a product can apply for a product passport for the product, this method describes the passport request submitted by the manufacturer. Accordingly, in step 722, the product information system, using the product information server, receives the passport request regarding the product from the manufacturer of the product, the passport request comprising product information regarding the product.

The passport request comprises a request that the product information system create a new, unique product passport for an individual product item manufactured by the manufacturer. The passport request can pertain to a product that is one or more of not yet manufactured, partially manufactured, and fully manufactured. The product can be in the possession of the requesting manufacturer. For example, the product information server comprises a web-based server. For example, the product information server comprises an application server. For example, the passport request further comprises payment, by the manufacturer, using the product information server, of an applicable registration fee.

The step of receiving the passport request with the product information comprises providing the manufacturer, by the product information system, using the product information server, with a method for transmitting to the product information server the product information.

For example, the product information server uploads the product information from the manufacturer. For example, the product information server uploads the product information from the manufacturer using a prescribed electronic product information upload form.

Preferably, but not necessarily, the product information system, using the product information server, translates the upload form to the product system user language.

For example, the product information comprises one or more of product basic information, product component information, product manufacture information, product manufacturer information, product comparison information, product untoward information, and the product contextual information. Preferably, but not necessarily, the product information comprises the product basic information.

Most preferably, but not necessarily, the product information comprises one or more of a product type, a product system user language, and a product system user location. The product information system is configured to use the product system user location to determine one or more product system user languages used in the product system user location. The product information system, using the product information server, translates the product information into one or more of the product system user languages. Alternatively, or additionally, the product information system, using the product information server, uses the product system user languages to prepare a prescribed electronic product information upload form (as described in the previous paragraph) in the languages that are anticipated as most useful for the system user.

Alternatively, or additionally, the product information system obtains the product manufacturer information from the system applicant information submitted by the product manufacturer when registering as a system user. For example, the product information server provides the manufacturer with a form usable by the manufacturer to input the product manufacturer information. Alternatively, or additionally, the application server receives from the manufacturer an upload of the product manufacturer information.

For example, the product information server comprises a web-based server. For example, the product information server comprises an application server. For example, the system applicant provides system applicant information about itself as part of the login process. For example, the system applicant information comprises one or more of a system applicant name, a system applicant address, a system applicant company registry number, a system applicant tax reference number, a product type manufactured by the system applicant, a number of factories operated by the system applicant, an origin of a component used by the system applicant, a criminal record of the system applicant, a factory condition in a factory operated by the system applicant, and other system applicant information. For example, the login process further comprises payment, by the system applicant, using the server, of an applicable registration fee. Block 722 then transfers control to block 723.

In step 723, the product information system, using the product information server, creates a product passport for the product, the product passport comprising a unique alphanumeric code. At this point in time, the product passport comprises an “empty” product passport analogous to a blank passport form prior to addition of a human being's personal information and photograph to the blank passport form. Block 723 then transfers control to block 724.

In step 724, the product information system, using the product information server, sends the product passport to the manufacturer. For example, the product information server makes available to the manufacturer a download of the product passport comprising the unique alphanumeric code. Block 724 then transfers control to block 725.

In step 725, the product information system, using the product information server, receives a manufacturing code application update, the manufacturing code application update comprising an update advising the product information system that the manufacturer has applied the alphanumeric code to the product. Block 725 then transfers control to block 726.

In step 726, the product information system, using the product information server, provisionally associates the product passport with the individual product. For example, associating comprises applying the product passport's unique alphanumeric code to the product to which it is being associated. Block 726 then transfers control to block 727.

In step 727, the product information system, using the product information server, receives further product information regarding the product from the manufacturer. Optionally, this step comprises a sub-step, performed before the step of receiving the further product information from the manufacturer, of requesting, by the product information system, using the product information server, further product information regarding the product from the manufacturer.

For example, the further product information comprises one or more of the product's unique alphanumeric code, product basic information, product component information, product manufacture information, product manufacturer information, product comparison information, product untoward information, and the product contextual information. Preferably, but not necessarily, the further product information comprises the product's unique alphanumeric code, the product basic information, the product component information, the product manufacture information, the product manufacturer information, the product comparison information, the product untoward information, and the product contextual information.

Alternatively, or additionally, the product information system obtains the further product manufacturer information from the system applicant information submitted by the product manufacturer when registering as a system user. For example, the product information server provides the manufacturer with a form usable by the manufacturer to input the further product manufacturer information. Alternatively, or additionally, the application server receives from the manufacturer an upload of the further product manufacturer information.

For example, the product basic information comprises one or more of a product type, a product manufacturer name, a product manufacture date, a product manufacture time, a product manufacture location, a product component product passport's unique alphanumeric code, a product shipping date, a product shipping time, a product typical wholesale price, a product typical retail price, a product code, a product description, a product number, a product Universal Product Code (UPC), and an exact product specification. The product component product passport comprises a product passport of a component of the product. The product component comprises one or more of a component of the product, a product ingredient, a raw material used in creating the product, a chemical used in creating the product, and a product part.

The product information system is configured to use the product system user location to determine one or more product system user languages used in the product system user location. The product information system, using the product information server, translates the product information into one or more of the product system user languages. Alternatively, or additionally, the product information system, using the product information server, uses the product system user languages to prepare a prescribed electronic product information upload form for the system user in the languages that are anticipated as most useful for the system user.

For example, a product can be manufactured in China, where the product information server provides the manufacturer with product information and an upload form in Cantonese, the same product can be transported by an English shipping system, during which the product information server provides the shipper with product information and an upload form in English, and the same product can then be sold in Germany, where the product information server provides the retailer with product information and an upload form in German, and a product information request can be entered regarding the same product by a system user in Finland, where the product information server provides the requester with product information, an inquiry form, and a response in Finnish. It should be noted that it would not be remotely possible for a human, using pencil and paper, to hypothetically mimic this invention, since aside from requiring millions of computations per second, a hypothetical human attempting to mimic embodiments of the invention would necessarily need to be capable of fluently and instantaneously performing cross-translations in all human languages. Thus, embodiments of the invention are only achievable using a specialized computer, as disclosed elsewhere in this application.

For example, the product component information comprises one or more of product raw material information, product ingredient information, and product chemical information. For example, the product raw material information comprises one or more of a raw material type, a raw material quantity, a raw material source, a raw material performance, and other raw material information. For example, the product ingredient information comprises one or more of an ingredient type, an ingredient quantity, an ingredient source, an ingredient performance, and other ingredient information. For example, the product chemical information comprises one or more of a chemical type, a chemical quantity, a chemical source, a chemical performance, and other chemical information.

For example, the product manufacture information comprises one or more of a product manufacture skill level, a product manufacture wage level, a product manufacture machine, a product manufacturing process step duration, a representative product manufacture wastage, a representative product manufacture error level, regional product manufacture information, and other product manufacture information. For example, the regional product manufacture information comprises information for a region in which the product is manufactured regarding one or more of a representative wage, a worker safety standard, a worker health standard, a manufacturer environmental standard, and a manufacturer ethical standard.

For example, the product manufacturer information comprises information submitted by the product manufacturer as a system applicant when registering on the product information system. For example, the product manufacturer information comprises the system applicant information submitted by the manufacturer.

For example, the product comparison information comprises product information for a comparable product. For example, the product comparison information comprises product information for a comparable product previously registered on the system. For example, a third-party information source provides the product comparison information. For example, the product comparison information comprises one or more of comparable product raw material information, comparable product ingredient information, and comparable product chemical information. For example, the comparable product raw material information comprises one or more of a raw material type, a raw material quantity, a raw material source, a raw material performance, and other raw material information. For example, the comparable product ingredient information comprises one or more of an ingredient type, an ingredient quantity, an ingredient source, an ingredient performance, and other ingredient information. For example, the comparable product chemical information comprises one or more of a chemical type, a chemical quantity, a chemical source, a chemical performance, and other chemical information.

For example, the product contextual information comprises third-party information source data relevant to the product, including one or more of a regional labor rate in a region where the produce is manufactured, a review of the product by a third-party authority, an independent review of reliability of the product relative to comparable products, and the like.

The product information system can request further product information as many times as needed to evaluate the product. For example, in case of a disagreement about the wage paid by the manufacturer's factory, the product information server requests the manufacturer to verify all wage information regarding the factory in order to resolve the identified discrepancy. Block 727 then transfers control to block 728.

In step 728, the product information system, using the product information server, validates the received further product information. For example, the product information server validates the received further product information using artificial intelligence. Validation comprises critically reviewing the received further product information in preparation to do one or more of accept and reject the received further product information.

The validation step comprises checking for one or more of product information mis-entry by the manufacturer, fraud, and another discrepancy. For example, if the manufacturer states that the factory pays twice the prevailing wage, but product comparison information previously received from the manufacturer states that the factory pays below the prevailing wage, the validation process identifies the discrepancy.

For example, the product information server validates the received further product information by comparing the received further product information with comparable product information received from a system participant associated with the product. For example, the system participant associated with the product comprises one or more of a manufacturer associated with the product, a transporter associated with the product, a retailer associated with the product, an end user associated with the product, a disposer associated with the product, a comparable system user that is comparable with the manufacturer, and a third-party information source comprising product information relevant to validation of the received product information.

For example, if the product comprises a washing machine that is actually Finnish, but the received product information states that the product is German, the validation process identifies the discrepancy and requires the manufacturer to correct it. Alternatively, or additionally to not validating the product, the product information server requests further information from the manufacturer to facilitate further product validation. For example, in the case of the Finnish washing machine, the product information server requests the manufacturer to verify all product information regarding the product. Block 728 then transfers control to block 729.

In step 729, the product information system, using the product information server, decides whether to accept the received product information. If the product information server determines that agreement between the received product information and the product comparison information is sufficient, the product information server accepts the received product information. If the product information server determines that the agreement is not sufficient, the product information server rejects the received product information.

The product information server can decide to accept a portion of the received product information while rejecting a remaining portion of the received product information, in which case the method branches depending on which portion of the received product information is being addressed. If the product information server decides to accept the received product information, block 729 then transfers control to block 731. If the product information server decides to reject the received system applicant information, block 729 then transfers control to block 730.

In step 730, the product information system, using the product information server, rejects the product and then notifies the manufacturer of the rejection of the product by the product information system. Block 730 then terminates the process.

In step 731, the product information system, using the product information server, obtains third-party product information regarding the product from a trusted third-party information source.

For example, the product information system obtains third-party product information from a trusted third-party information source. Alternatively, or additionally, the third-party product information comprises product information that the product information system generates using a product passport for a comparable product that is one or more of related to the product and similar to the product. For example, the third-party product information comprises third-party product information regarding one or more of the manufacturer and the product. Preferably, but not necessarily, the third-party product information comprises third-party product information regarding both the manufacturer and the product. For example, the product comparison comprises information regarding an average regional wage in a region of manufacture where the system applicant's factory is located. For example, the third-party information source comprises one or more of a federal company registry, a federal tax registry, a state company registry and a state corporate tax registry. Block 731 then transfers control to block 732.

In step 732, the product information system, using the product information server, generates product comparison information usable to compare the product with a comparable product. For example, generating comprises one or more of obtaining and locating. For example, obtaining comprises obtaining from one or more of the trusted third-party source and a comparable system participant. For example, generating comprises locating product comparison information relating to the product and comprised in the product information system.

For example, the product comparison information comprises product information for a comparable product. For example, the product comparison information comprises product information for a comparable product previously registered on the system. For example, a third-party information source provides the product comparison information. Block 732 then transfers control to block 733.

In step 733, the product information system, using the product information server, overlays two or more of the product information, the third-party product information, and the product comparison information. Block 733 then transfers control to block 734.

In step 734, the product information system, using the product information server, validates the product. Validation comprises critically reviewing the product in preparation to do or more of accept the product and reject the product. For example, the product information server validates the product using artificial intelligence. Block 734 then transfers control to block 735.

In step 735, using the overlay, the product information system, using the product information server, makes a product decision. For example, the step of making the product decision comprises comparing two or more of the received product information, the third-party product information, and product comparison information.

The product decision comprises one or more of a final product acceptance, a final product rejection, and a provisional product rejection. The provisional product rejection comprises a request, by the system to the manufacturer, for further product information usable by the product information server to change the provisional product rejection to one or more of a final product acceptance and a final product rejection. Thus, if the product information system decides on a provisional product rejection, the system loops back to step 725 to request further information usable by the product information server to change the provisional product rejection to one or more of a final product acceptance and a final product rejection. The system can make such requests for further product information multiple times if the system deems this appropriate. If the product information system decides on a final product acceptance, block 735 then transfers control to block 736. If the product information system decides on a final product rejection, block 735 then transfers control to block 730.

In step 736, the product information system, using the product information server, accepts the product on the product information system. Block 736 then transfers control to block 737.

In step 737, the product information system, using the product information server, authenticates the product as a legitimate, known product on the product information system. Block 737 then transfers control to block 738.

In step 738, the product information system, using the product information server, notifies the manufacturer of the acceptance of the product on the product information system. Block 738 then transfers control to block 739.

In step 739, the product information system, using the product information server, associates the product passport comprising its own unique alphanumeric code with the individual product. For example, associating comprises applying the product passport's unique alphanumeric code to the product to which it is being associated.

For example, the product information server associates with the product's product passport one or more of the product information, the product's unique alphanumeric code, the third-party manufacturer information regarding the manufacturer, the third-party product information regarding the product, and the system applicant information previously submitted by the manufacturer. Preferably, but not necessarily, the product information server associates with the product's product passport the product information, the product's unique alphanumeric code, the third-party manufacturer information regarding the manufacturer, the third-party product information regarding the product, product contextual information, and the system applicant information previously submitted by the manufacturer. For example, the product passport comprises a passport file. Block 739 then transfers control to block 740.

In step 740, the product information system, using the product information server, populates the product information into the product passport, thereby completing an initial product passport. Block 740 then transfers control to block 742.

In step 742, the product information system, using the product information server, stores the product passport. For example, the product information system stores the product passport in the database.

Once a product has been accepted into the system as set forth in steps 722 to 742, other system users can access product information regarding the product. Preferably, but not necessarily, once the product has been accepted into the system, all other system users can access the product information regarding the product. Block 742 then transfers control to block 755.

In step 755, the product information system, using the product information server, receives from a system user a user request for item-specific product information regarding the product.

For example, the user request further comprises one or more of a user language and a user location. Preferably, but not necessarily, the product information system, using the product information server, uses the user location to determine one or more user languages used in the user location. Block 755 then transfers control to block 756.

In step 756, the product information system, using the product information server, extracts from the product passport the requested item-specific information regarding the product. Block 756 then transfers control to block 757.

In step 757, the product information system, using the product information server, extracts product-related information from a related-product passport of a related product that is related to the product. For example, the product information system uses the product-related information to compare the product to the related product for validation of the item-specific information relating to the product item. Block 757 then transfers control to block 758.

In step 758, the product information system, using the product information server, obtains from the product information system user-requested product information. For example, the application server sends a request fulfillment message to the product information server comprising requested product information. For example, the application server sends a request fulfillment message to the product information server comprising publicly available requested product information. For example, in the case where the retailer forwards the user request, the product information server sends the retailed a request fulfillment message including the requested information. For example, the retailer displays the request fulfillment message for viewing by the system user. For example, the retailer displays the request fulfillment message for viewing by the system user using the system user device. For example, the product information comprises one or more of the product's unique alphanumeric code, product basic information, product component information, product manufacture information, product manufacturer information, product comparison information, product untoward information, and product contextual information. Preferably, but not necessarily, the product information comprises the product's unique alphanumeric code, the product basic information, the product component information, the product manufacture information, the product manufacturer information, the product comparison information, the product untoward information, and the product contextual information.

For example, the product basic information comprises one or more of a product type, a product manufacturer name, a product manufacture date, a product manufacture time, a product manufacture location, a product system user language, a product system user location, a product component product passport's unique alphanumeric code, a product shipping date, a product shipping time, a product typical wholesale price, a product typical retail price, a product code, a product description, a product number, a product Universal Product Code (UPC), and an exact product specification.

For example, the product component information comprises one or more of product raw material information, product ingredient information, and product chemical information. For example, the product raw material information comprises one or more of a raw material type, a raw material quantity, a raw material source, a raw material performance, and other raw material information. For example, the product ingredient information comprises one or more of an ingredient type, an ingredient quantity, an ingredient source, an ingredient performance, and other ingredient information. For example, the product chemical information comprises one or more of a chemical type, a chemical quantity, a chemical source, a chemical performance, and other chemical information.

For example, the product manufacture information comprises one or more of a product manufacture skill level, a product manufacture wage level, a product manufacture machine, a product manufacturing process step duration, a representative product manufacture wastage, a representative product manufacture error level, regional product manufacture information, and other product manufacture information. For example, the regional product manufacture information comprises information for a region in which the product is manufactured regarding one or more of a representative wage, a worker safety standard, a worker health standard, a manufacturer environmental standard, and a manufacturer ethical standard.

For example, the product comparison information comprises information the product information server has received from a system participant associated with the product. That is, the product comparison information comprises information the product information server has received from one or more of a manufacturer associated with the product, a transporter associated with the product, a retailer associated with the product, an end user associated with the product, a disposer associated with the product, a system participant associated with a comparable product that is comparable with the product, and a third-party information source comprising product information relevant to validation of the received product information. For example, the system participant comprises the manufacturer. For example, the product comparison information is usable by the product information system to perform the validation by independently validating the received product information.

For example, the product contextual information comprises third-party information source information relevant to the product, including one or more of a regional labor rate in a region where the produce is manufactured, a review of the product by a third-party authority, an independent review of reliability of the product relative to comparable products, and the like.

Optionally, the method comprises a further step of receiving, by the product information server, from the system user, a request for additional product information regarding the product item. The product information server may grant access to the system user to acquire access to any available additional product information, either for free or for a fee. In embodiments, where information requiring a payment is requested, the end user may be charged by the application server of the product information server (if registered for example) or by the online retailer. In particular, the end user may have an existing account with online retailer which can be used to deduct the relevant charges. In embodiments, the online retailer may have obtained the product information that is available about the product without charge from the product information system in advance, whereas the product information requiring payment is requested from the product information server in real time. Alternatively, the online retailer may also have obtained the chargeable information from information distributor in advance, so that request and response are optional. Block 758 then transfers control to block 772.

In step 772, the product information system, using the product information server, presents the requested product information to the system user. For example, the product information system presents the requested product information to the system user on a website. For example, the product information system presents the requested product information to the system user on the website of a retailer. For example, the retailer comprises one or more of a direct sale manufacturer, a hospital, a surgery, a wholesaler, an end shop, and an online retailer.

Optionally, the method further comprises an additional step, performed after the obtaining step and before the presenting step, of translating, by the product information system, using the product information server, the requested product information into the user language. Block 472 then terminates the process. Block 772 then transfers control to block 774.

In step 774, the product information system, using the product information server, receives, from a first system user, first system user information. The first system user information comprises first system user identifying information identifying the first system user. The first system user information further comprises first system user product relationship information regarding a relationship of the first system user to the product. The first system user information further comprises first system user transaction information identifying a desired transaction of the first system user with a product, the desired transaction intended to transfer the product from the first system user to a second system user. The first system user transaction information further comprising the product's unique alphanumeric code. For example, the first system user comprises a retailer of the product. For example, the product comprises a television.

For example, the product information system does not require the second system user to be registered as an authorized system user.

The first system user identifying information comprises one or more of a first system user credential identifying the first system user of the product as an authorized system user, the product's unique alphanumeric code, a location of the first system user, the first system user's name, the first system user's address, the first system user's email address, the first system user's telephone number, the first system user's facsimile number, the first system user's social media handle, and other information regarding the first system user. The first system user identifying information further comprises product relationship information regarding a relationship of the first system user to the product. For example, the first system user comprises a retailer of the product. For example, the retailer comprises one or more of a direct sale manufacturer, a hospital, a surgery, a wholesaler, an end shop, and an online retailer.

For example, the transaction comprises one or more of a past transaction, an ongoing transaction, and a desired transaction. For example, the first system user comprises a retailer. For example, the first system user transaction comprises a sale the retailer desires to make of the product to a consumer.

For example, the transaction comprises one or more of a logistics transaction, a product integration transaction, a product repair, a product sale, a product lease, a product loan, a product disposal, and another transaction. For example, the logistics transaction comprises transportation of the product. For example, the product integration transaction comprises combining a plurality of products to make one or more of a bundle of products and a new product. For example, the product sale comprises a product sale to one or more of a retailer, a wholesaler, an end user, and a disposer. For example, the product disposer performs one or more of product consumption, recycling, disposal, and destruction. Block 774 then transfers control to block 775.

In step 775, the product information system, using the product information server, records the relationship of the first system user to the product. For example, the first system user comprises a seller. The relationship comprises one or more of a possession, a rental, a lease, a use, an integration of the product into a second product, a consumption of the product, and a destruction of the product. For example, the possession comprises possession pursuant to transportation of the product. For example, the possession comprises possession by a transporter pursuant to transportation of the product. For example, the possession comprises possession by a transporter pursuant to transportation of the product from a manufacturer to a retailer. For example, the possession comprises possession by a transporter pursuant to transportation of the product from a retailer to an end user. For example, the transaction comprises a purchase by a medical body for use of the product in a prescription for a patient. For example, the transaction comprises an acquisition through financing secured against the purchase of the product. For example, the integration can comprise replacement of a spare part of the second product. Block 775 then transfers control to block 776.

In step 776, the product information system, using the product information server, records the first system user transaction information. Block 776 then transfers control to block 778.

In step 778, the product information system, using the product information server, receives second system user information comprising second system user identifying information. The second system user information comprises second system user identifying information identifying the second system user. The second system user information further comprises second system user product relationship information regarding a relationship of the second system user to the product. The second system user information further indicating that the second system user is completing the desired transaction. The second system user information further comprises the product's unique alphanumeric code. For example, the second system user comprises a purchaser of the product.

The second system user identifying information comprises one or more of a second system user credential identifying the second system user of the product as an authorized system user, the product's unique alphanumeric code, a location of the second system user, the second system user's name, the second system user's address, the second system user's email address, the second system user's telephone number, the second system user's facsimile number, the second system user's social media handle, and other information regarding the second system user. The second system user identifying information further comprises product relationship information regarding a relationship of the second system user to the product. For example, the second system user comprises an end user of the product. For example, the second system user purchases the product from the first system user. Block 778 then transfers control to block 780.

In step 780, the product information system, using the product information server, receives from the first system user transaction information. Alternatively, or additionally, the product information system, using the product information server, receives from the second system user transaction information. For example, the transaction information comprises a transaction confirmation confirming one or more of completion and non-completion of the desired transaction.

Optionally, the product information server requests from the second system user a transaction confirmation confirming one or more of completion and non-completion of the desired transaction. For example, the product information server requests from the second system user a sale confirmation confirming one or more of completion and non-completion of the desired sale of the product from the first system user to the second system user. Alternatively, or additionally, the first system user identifying information comprises the transaction confirmation. Optionally, the product information server requests from the second system user second system user identifying information including one or more of a second system user credential identifying the second system user as an authorized system user, the product's unique alphanumeric code, a date of sale, a time of sale, a price of sale, a location of sale, a product code, the second system user's name, the second system user's address, the second system user's email address, the second system user's telephone number, the second system user's facsimile number, the second system user's social media handle, a product warranty start date, a product warranty termination date, a product warranty duration, a product warranty cover term, a product delivery date, and other information regarding the second system user.

Optionally, the product information server requests from the first system user a transaction confirmation confirming one or more of completion and non-completion of the desired transaction. For example, the product information server requests from the first system user a sale confirmation confirming one or more of completion and non-completion of the desired sale of the product from the first system user to the second system user. Alternatively, or additionally, the first system user identifying information comprises the transaction confirmation. Optionally, the product information server requests from the first system user first system user identifying information including one or more of a first system user credential identifying the second system user as an authorized system user, the product's unique alphanumeric code, a date of sale, a time of sale, a price of sale, a location of sale, a product code, the first system user's name, the first system user's address, the first system user's email address, the first system user's telephone number, the first system user's facsimile number, the first system user's social media handle, a product warranty start date, a product warranty termination date, a product warranty duration, a product warranty cover term, a product delivery date, and other information regarding the first system user.

The product information server records a change of ownership of the product from the first system user to the second system user. The product information server updates a product ownership record comprised in the product passport. If the transaction is not completed, block 780 terminates the process. If the transaction is completed, block 780 then transfers control to block 781.

In step 781, the product information system, using the product information server, validates the received transaction information. For example, the product information server validates the received transaction information using artificial intelligence. For example, the product information server validates the received transaction information by comparing the received transaction information with product comparison information. The product comparison information comprises product information that the product information server has received from a system participant associated with the product. That is, the product comparison information comprises product information that the product information server has received from one or more of a manufacturer associated with the product, a transporter associated with the product, a retailer associated with the product, an end user associated with the product, a disposer associated with the product, a system participant associated with a comparable product that is comparable with the product, and a third-party information source comprising product information relevant to validation of the received product information. For example, the system participant comprises the manufacturer. For example, the product comparison information is usable by the product information system to perform the validation by independently validating the received product information. If the product information server determines that agreement between the received product information and the product comparison information is sufficient, the product information server accepts the received product information. If the product information server determines that the agreement is not sufficient, the product information server rejects the received product information.

The validation step comprises checking for one or more of product information entry by the manufacturer, location of the transaction, the transaction price, lack of fraud in the transaction, a proper product supply chain, correctness of a transaction, a correct first system user, a correct second system user, release of the finance charge to which the product is subject, transaction authorization for the transaction of the first system user, transaction authorization for the transaction of the second system user, and another validation criterion. Preferably, but not necessarily, the validation step comprises checking for the product information entry by the manufacturer, the location of the transaction, the transaction price, the lack of fraud in the transaction, the proper product supply chain, correctness of a transaction, the correct first system user, the correct second system user, the release of the finance charge to which the product is subject, the transaction authorization for the transaction of the first system user, and the transaction authorization for the transaction of the second system user. For example, in the case of a purchase of the product, the product information server validates the product information entry by the manufacturer, the location of the purchase, the purchase price, the lack of fraud in the purchase, the proper product supply chain, the correctness of the purchase, the correct second system user, the correct first system user, the release of the finance charge to which the product is subject, and the purchase authorization for the purchase of the purchasing system user.

For example, the system prohibits the purchase authorization because of one or more of the first system user's age, the first system user's lack of a required permit, the first system user being subject to a sanction, the first system user lacking a needed license for purchase of a restricted product, and another prohibition reason. For example, the system prohibits the transaction authorization because of one or more of the second system user's age, the second system user's lack of a required permit, the second system user being subject to a sanction, the second system user lacking a needed license for purchase of a restricted product, and another prohibition reason.

For example, the system prohibits the transaction authorization because of one or more of the first system user's age, the first system user's lack of a required permit, the first system user being subject to a sanction, the first system user lacking a needed license for purchase of a restricted product, and another prohibition reason. For example, the incorrect second system user comprises a prohibited second system user. For example, the system prohibits the transaction authorization because of one or more of the second system user's age, the second system user's lack of a required permit, the second system user being subject to a sanction, the second system user lacking a needed license for purchase of a restricted product, and another prohibition reason. If the product information server decides to reject the received purchase information, the process stops. If the product information server decides to accept the received purchase information, block 781 then transfers control to block 782.

In step 782, the product information system, using the product information server, records a transfer of ownership of the product from the first system user to the second system user. Alternatively, or additionally, the product information system uses the application server to record the change of ownership. For example, the change of ownership comprises a transfer of ownership. The product information server updates a product ownership record comprised in the product passport. For example, where a second system user comprises a transporter and the second system user accepts the product only for transport, the change of possession does not transfer ownership.

Optionally, the step of recording the change of ownership comprises a sub-step of receiving product comparison information from a system participant associated with the product.

Optionally, the step of recording the change of ownership further comprises an additional sub-step, performed after the sub-step of receiving the product comparison information, of comparing the received transaction information with the product comparison information.

Optionally, the step of recording the change of ownership further comprises an additional sub-step, performed after the comparing sub-step, of determining if agreement between the received transaction information and the product comparison information is sufficient. Block 782 then transfers control to block 786.

In step 786, the product information system, using the product information server, updates a product possession record comprised in the product passport. For example, the step of updating the product possession record reflects the transaction. For example, if the transaction comprises a sale of a consumer good from a retailer to a consumer, the step of updating comprises recording the consumer as the new possessor and owner of the consumer good.

Updating comprises one or more of adding new product ownership information, supplementing existing product ownership information with new product ownership information, and replacing the existing product ownership information with new product ownership information. The product ownership information comprises one or more of the product's unique alphanumeric code, a date of sale, a time of sale, a price of sale, a location of sale, a product code, a financing arrangement used in the sale, a medical insurance funding arrangement used in the sale, the owner's name, the owner's address, the owner's email address, the owner's telephone number, the owner's facsimile number, the owner's social media handle, and other information regarding the owner. For example, the medical insurance comprises one or more of government medical insurance and private medical insurance.

For example, the step of updating the product passport reflects the transaction. For example, if the transaction comprises a sale of a consumer good from a retailer to a consumer, the step of updating comprises recording in the product passport the consumer as the new possessor and owner of the consumer good. Block 786 then terminates the process.

FIG. 8 is a flow chart of a method 800 for using a product passport and a product information system for providing item-specific product information. More specifically, FIG. 8 is a flow chart of a method 800, using a product passport and a product information system, for creating an auditable trail of one or more of ownership and location of the product.

The order of the steps in the method 800 is not constrained to that shown in FIG. 8 or described in the following discussion. Several of the steps could occur in a different order without affecting the final result.

In step 810, the product information system, using the product information server, records an acceptance of a system applicant as a system user. For example, the step of recording the acceptance of the system applicant as the system user comprises recording one or more of product ownership and product location. For example, the step of recording the acceptance of the system applicant as the system user comprises recording both the product ownership and the product location. For example, the step of recording the acceptance of the system applicant as the system user comprises recording the acceptance of the system applicant as the system user in the product passport. Steps in this method can be performed at a point different from the event that is being recorded. Block 810 then transfers control to block 820.

In step 820, the product information system, using the product information server, records a passport request regarding the product from the system user. For example, the step of recording the passport request comprises recording one or more of product ownership and product location. For example, the step of recording the passport request comprises recording both the product ownership and the product location. For example, the step of recording the passport request comprises recording the passport request in the product passport. Steps in this method can be performed at a point different from the event that is being recorded. Block 820 then transfers control to block 830.

In step 830, the product information system, using the product information server, records creation, by the product information system, using the product information server, of a product passport for the product, the product passport comprising a unique alphanumeric code. For example, the step of recording the creation of the product passport comprises recording one or more of product ownership and product location. For example, the step of recording the creation of the product passport comprises recording both the product ownership and the product location. For example, the step of recording the creation of the product passport comprises recording in the product passport. Steps in this method can be performed at a point different from the event that is being recorded. Block 830 then transfers control to block 840.

In step 840, the product information system, using the product information server, records product information received from a system user regarding the product. For example, the step of recording the product information comprises recording product manufacture information received from a manufacturer regarding the product. For example, the step of recording the product information comprises recording one or more of product ownership and product location. For example, the step of recording the manufacturing information comprises recording both the product ownership and the product location. For example, the step of recording the manufacturing information comprises recording in the product passport. Steps in this method can be performed at a point different from the event that is being recorded. Block 840 then transfers control to block 850.

In step 850, the product information system, using the product information server, records acceptance of the product by the product information system. For example, the step of recording the acceptance of the product by the product information system comprises recording one or more of product ownership and product location. For example, the step of recording the acceptance of the product by the product information system comprises recording both the product ownership and the product location. For example, the step of recording the acceptance of the product by the product information system comprises recording in the product passport the acceptance of the product by the product information system. Steps in this method can be performed at a point different from the event that is being recorded. Block 850 then transfers control to block 860.

In step 860, the product information system, using the product information server, records transaction information regarding a completed transaction changing one or more of the product ownership and the product location. For example, the step of recording the change of product ownership comprises recording a change of product ownership from a first system user to a second system user. For example, the step of recording the transaction information regarding the completed transaction comprises recording one or more of product ownership regarding the completed transaction and product location regarding the completed transaction. For example, the step of recording the transaction information regarding the completed transaction comprises recording both the product ownership regarding the completed transaction and the product location regarding the completed transaction. For example, the step of recording the transaction information regarding the completed transaction comprises recording the transaction information regarding the completed transaction in the product passport. Steps in this method can be performed at a point different from the event that is being recorded. Block 860 then transfers control to block 870.

In step 870, the product information system, using the product information server, records the change of the one or more of the product ownership and the product location. For example, the step of recording the change of the one or more of the product ownership and the product location comprises recording the change in the product passport. For example, the step of recording the change of product ownership comprises recording the change of product ownership from a first system user to a second system user. Steps in this method can be performed at a point different from the event that is being recorded. Block 870 then terminates the process.

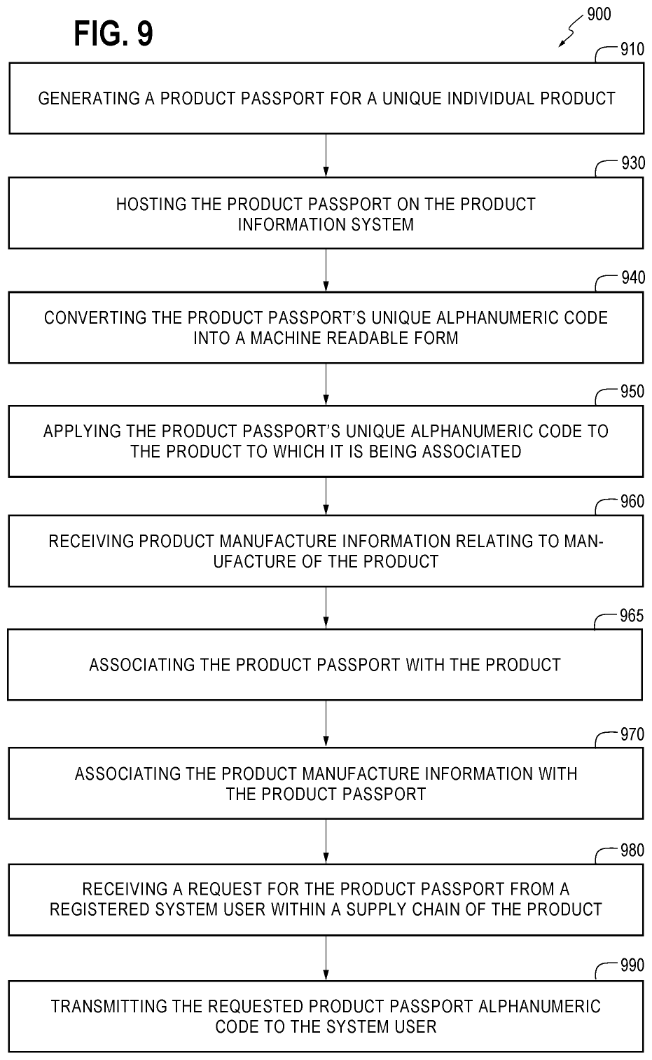

FIG. 9 is a flow chart of a method 900 for using a product passport and a product information system for providing item-specific product information. More specifically, FIG. 9 is a flow chart of a method 900, using a product passport and a product information system, for creating a product passport and populating the product passport with item-specific product information, and for providing item-specific product information to a system user in response to a system user request.

The order of the steps in the method 900 is not constrained to that shown in FIG. 9 or described in the following discussion. Several of the steps could occur in a different order without affecting the final result.

In step 910, the product information system, using the product information server, generates a product passport for a unique individual product. Block 910 then transfers control to block 930.

In step 930, the product information system, using the product information server, hosts the product passport on the product information system. Block 930 then transfers control to block 940.

In step 940, the product information system, using the product information server, converts the product passport's unique alphanumeric code into a machine readable form. Block 940 then transfers control to block 950.

In step 950, the product information system, using the product information server, applies the product passport's unique alphanumeric code to the product to which it is being associated. Block 950 then transfers control to block 960.

In step 960, the product information system, using the product information server receives product manufacture information relating to manufacture of the product. Block 960 then transfers control to block 965.

In step 965, the product information system, using the product information server, associates the product passport with the product. Block 920 then transfers control to block 970.

In step 970, the product information system, using the product information server, associates the product manufacture information with the product passport. Block 970 then transfers control to block 980.

In step 980, the product information system, using the product information server receives a request for the product passport from a registered system user within a supply chain of the product. Block 980 then transfers control to block 990.

In step 990, the product information system, using the product information server, transmits the requested product passport alphanumeric code to the system user. Block 990 then terminates the process.

Using the product information provided by the manufacturers and the third-party information source, the end user or any other authorized user (such as a retailer comparing their stock, a transporter looking at their stock or stock in transit or a research or analysis entity) is able optionally to build a comparison table on the product information system between all of the aforementioned free and paid-for information for several unique product passports corresponding to the same product type (i.e., 77-inch flat screen TV) to perform a comparison e.g. of competing offerings in the same store or between products simultaneously available in different retailers (i.e. price, specification, provenance, factory condition, product performance, product review and the like).

Table 1 presents an exemplary product comparison table comprising product comparison information that the system can provide to a system user comparing two products that the system user is considering for purchase:

TABLE 1
PRODUCT COMPARISON TABLE

| | | | | | Manufacturer |
|---|---|---|---|---|---|
| | | | | | Wage as a % of |
| | | | Manufacturer | | Average Regional |
| | | | Stated Worker | Average Regional | wage (>100% = |
| | | | Hourly Wage | Worker Hourly Wage | good for |
| | | Manufacturing | (manufacturer | (independently | manufacturer's |
| Product | Company | Region | supplied) | sourced data) | workers) |
| TV | A | Region A | $0.50 | $0.40 | 125% |
| model A | | | | | |
| TV | B | Region B | $10.00 | $15.00 | 67% |
| model B | | | | | |

The product comparison table comprises an item-specific product comparison table in which features of the two products are listed and compared. For example, the features of the two products are obtained from the products' respective manufacturers. The system can show the product description table to the system user free of charge to the client. Alternatively, or additionally, the system charges the system user to display the product description table.

As shown by the product comparison table, the first product item comprises a television model A, sold by company A, manufactured in region A at a manufacturer wage of 50 cents per hour. The second product item comprises a television model B, sold by company B, manufactured in region B at a manufacturer wage of $10.00 per hour.

The product comparison table further comprises a product comparison table in which the system displays a manufacturer wage of the manufacturer. Preferably, but not necessarily, the system also displays one or more of a manufacturing region in which the product is manufactured and an average regional wage for the manufacturing region. The system can show this further information, comprising one or more of the manufacturing region and the average regional wage, free of charge. Alternatively, or additionally, the system charges the system user to display the further information. The third-party information source can verify the manufacturer wage information. Alternatively, or additionally, the third-party information source can provide the average regional wage information. In this particular example, the product comparison table clarifies that while the manufacturer wage for TV Model A is much lower than the manufacturer wage for TV Model B, the former is actually higher when compared to the average regional wage. Such considerations might lead the system user to decide to purchase TV Model A.

Trade buyers may also access the product information on the product information system, for example, at a flat rate monthly charge per product type per range of searches made on the database based on most of the searchable fields and with the option to buy extra standard or specially commissioned data. In this way traders can be encouraged to use the product information server as part of their buying and sales and marketing activity. The product information can be accessed either by the individual products' product passport's unique alphanumeric code or by any of the other product information fields including one or more of a batch code of chemicals used, a date of manufacture, a location of manufacture, the current location while in transit of the product and the like.

Manufacturers of higher value products are encouraged to use very hard to remove stickers or to print directly onto the product to carry the product passport's unique alphanumeric code but the product serial number is still recorded on the product information system along with a description so it could quickly become a default check on recovery of stolen products to trace the owner via product information server using the serial number and the product passport's unique alphanumeric code, if still present. If all of a certain manufacturer's product was known to be marked with product passport unique alphanumeric codes from product information server then the absence of the product passport's unique alphanumeric code would be indicative of an untoward product. Examples of an untoward product include one or more of a stolen product, a defective vaccine, a problematic vaccine dose, likely damage to the product, a product subject to a finance charge, a product subject to a past back door sale, product content dilution, a corrupt medical product, and a product manufactured using one or more of unpermitted sub-contracting, slavery, and sweatshop conditions. The labor content may compel manufacturers to improve one or more of a labor standard, a factory condition, a quality of a chemical ingredient quality, and the like. Embodiments of the invention therefore have the potential to have an impact on other technology areas including one or more of medicine, an environmental impact of a product, and human rights. Exemplary information that the end user can provide includes the retailer from whom the product was purchased, date and time of purchase along with retailer invoice number. The use of such a product information service can entail a small charge. Second-hand sales of a product that is already registered with the product information server can also be registered through the product information server with one or more of the product passport's unique alphanumeric code and the system user's password preventing a thief from hacking in and changing details.

The product can be one or more of manufactured, fabricated, assembled, and otherwise processed. The product can comprise one or more of a crop, a food and an extracted raw material. For example, the extracted raw material comprises one or more of coal and salt. Thus, the product may represent a product that needs further processing and is supplied to, for example, another manufacturer or to a business or commercial end user of the product. It may therefore be possible to trace the combination of two or more products into one new product (for example a car stereo, speakers and the car into which they are fitted).

A particular product may be compared on the product information system against one or more other products of a same type made by the same manufacturer. Alternatively, or additionally, a particular product may be compared on the product information system against a generic product of the same type made by a generic manufacturer.

An advantage provided by embodiments of the invention is providing a consumer considering a product purchase with product additional information regarding a product of interest, information that uses the product passport on the product information system to provide item-specific product information relating to the individual product rather than information relating to a generic product type.

A further advantage provided by embodiments of the invention is using the product passport to provide item-specific product information about several products so that the consumer can discover more information about the products in order to exercise an informed decision as to which product to buy. A still other advantage provided by embodiments of the invention is using the product passport in conjunction with other information on the product information system to provide item-specific product information so that the consumer can get an answer to a question such as one or more of, “What is it?”, “Where is it from?”, “When was it made?”, “Who made it?” and “Was the way in which it was made ethical?” A still additional advantage of embodiments of the invention is that using the product passport to provide item-specific product information informs a consumer's purchasing decision. For example, the informed consumer purchasing decision comprises one or more of a present purchasing decision and a future purchasing decision. For example, the purchasing decision comprises a decision regarding one or more of a merchant to patronize, a product to purchase, a degree of influence of an ethical issue used by the customer in making a purchasing decision, and a degree of influence of an environmental issue used by the customer in making a purchasing decision.

A still additional advantage of embodiments of the invention is providing a product passport on the product information system which is configured to provide item-specific product information and so enables a consumer to answer purchasing questions one or more of quickly, easily, in real time and at a point-of-sale. A yet other advantage of embodiments of the invention is that such availability of product information may render it increasingly unacceptable to consumers not to know these facts about their intended purchases including one or more of ethical, environmental and human rights facts. A still other advantage of embodiments of the invention is that accordingly, products of interest that cannot be checked for criteria comprising one or more of ethical, environmental and human rights facts might not get purchased. Another advantage of embodiments of the invention is that retailers may be incentivized to do one or more of acquire information regarding one or more of ethical, environmental and human rights facts regarding their product and provide the product information to the system user. A yet other advantage of embodiments of the invention is that one or more of manufacturers and producers may be similarly incentivized to do one or more of acquire information regarding one or more of ethical, environmental and human rights facts regarding their product and provide the product information to the system user through the product information system.

A yet other advantage of embodiments of the invention is that the product passport for the individual product can comprise product information about one or more of the product item's origin, the product item's environmental manufacturing impact, the product item's environmental product content, the product item's ethical impact, and the product item's social impact. A yet other advantage provided by embodiments of the invention is that this wealth of information allows for analysis of the product item by a system user that is one or more of faster, more substantial, more relevant, and more accurate than is possible with any prior art system. An additional advantage provided by embodiments of the invention is that product passports of different individual items can be compared to enable a consumer to form a real-time product comparison view between product items in respect of the relevant criteria. For example, the consumer can compare one or more of manufacturer environmental standards and manufacturer ethical production standards for a packet of beans grown in Kenya with beans grown in Chile.

Advantages of embodiments of the invention include providing a product passport on the product information system which is configured to provide item-specific product information that is held independently of a supply chain of the product including a manufacturer of the product, a seller of the product, and a purchaser of the product. Another advantage provided by embodiments of the invention include providing the product passport on the product information system in a way that is easily accessible by a user wishing to interrogate a database comprising product information on the product. An additional advantage provided by embodiments of the invention include providing the product passport on the product information system that is configured to provide item-specific product information so that it is held independently of a supply chain of the product including a manufacturer of the product, a seller of the product, and a purchaser of the product.

Other advantages of embodiments of the invention include employing a specialized computer uniquely adapted to carrying out the methods and systems outlined in this application. Another advantage of embodiments of the invention is utilizing artificial intelligence simultaneously to engage with thousands or millions or even billions of authorized computer users, each in their own language, using the translation capabilities outlined in more detail above. A yet further advantage of embodiments of the invention is using artificial intelligence to manipulate the data that is submitted by those users in real time in order to perform one or more of the various properties and functions newly disclosed in the present patent application. These properties and functions comprise one or more of: creating an alphanumeric code associated with a product; associating the alphanumeric code with an individual product passport of the product; enabling authorized system users to associate with the product passport product information relating to the supply chain of the product; enabling authorized system users accessing the system to associate with the product passport product information relating to the supply chain of the product, the product information comprising one or more of an updated data record regarding the individual product item and a new data record regarding the individual product item; obtaining system applicant information regarding a system applicant, the system applicant information comprising one or more of an updated data record regarding the system applicant and a new data record regarding the system applicant; validating the received system applicant information including checking for a discrepancy in the system applicant information; validating the received product information including checking for a discrepancy in the product information; presenting product information to the system user; presenting the product information in comparison to other product information pertaining to other comparable products; presenting the product information in comparison to other product information associated with comparable system users; and combining the records about one or more of multiple system users and multiple individual product items to provide analytic insights to a system user requesting the analysis.

Such a specialized computer is the only means of executing these functions, which are disclosed in greater detail throughout this application and the drawings, at the needed scale of number of users and number of operations.

Advantages offered by embodiments of the invention include that embodiments of the invention track individual items rather than prior art methods that track a class of nominally identical products. Another advantage of embodiments of the invention is providing a different product passport for an individual item rather than the current prior art system of universal product codes (UPCs) that assigns the same UPC to products that are nominally identical. A further advantage is that embodiments of the invention provide a serial numbering system that is capable of being generally applicable to all manufacturers rather than being unique to an individual manufacturer. Yet other advantages provided by embodiments of the invention is creating a system that associates information with an individual product at time of manufacture.

Another advantage of embodiments of the invention is providing a method and system that automatically generates its own system user information configured to facilitate comparison of a system applicant wishing to join the system as a system user with existing system users. A yet further advantage of embodiments of the invention is providing a method and system that automatically generates its own system user information configured to facilitate comparison of a new product to be registered with a product passport on the system with other comparable product passports that are already on the system. A further advantage of embodiments of the invention is providing a method and system that automatically generates its own comparison product information configured to facilitate comparison of a product in which a consumer is interested with a related product.

A further advantage of embodiments of the invention is providing a code that is unique to an individual product item rather than a product class as with Universal Product Codes (UPC's). A still other advantage of embodiments of the invention is providing an item-specific product code that can be affixed to a product in analogy with current application of UPC's but with all the other additional advantages not available using UPC's.

A key advantage of embodiments of the invention is that none of the character fields in the unique alphanumeric code of each individual product passport comprises a specific meaning such as a GS1 country code, in sharp contrast to existing prior art systems' current method of using one or more of a bar code, a quick response (QR) code, and a data matrix code. Therefore, a substantial advantage of embodiments of the invention is that, unlike the prior art such as Universal Product Codes (UPCs), embodiments of the invention offer an unlimited number of available data fields. A still further advantage of embodiments of the invention is that, again unlike the prior art such as UPCs, embodiments of the invention do not use a data field for a fixed purpose (for example, a country code or a size of a packet). A yet other advantage of embodiments of the invention is that the unlimited number of data fields offered allows for product passports comprising a virtually infinite number of alphanumeric codes, enabling a user to easily look up a product using the alphanumeric code. A yet other advantage of embodiments of the invention is that the unlimited number of data fields offered allows for product passports comprising a virtually infinite number of alphanumeric codes, enabling a user to look up a product in real time using the alphanumeric code.

Accordingly, a yet other advantage of embodiments of the invention is that substantial efficiency is promoted, allowing more information to be stored by using a product passport's unique alphanumeric code solely as a means of connecting with product information in a database. A yet other advantage provided by embodiments of the invention is that the product information relating to an individual product (and not just to a generic product type) can be stored. A further advantage of embodiments of the invention is that the product information system can easily access the individual product information. Another advantage of embodiments of the invention is that the product information system can easily update the individual product information.

Further advantages of embodiments of the invention include providing an information or communication technology having an impact on other technology areas, including but not limited to medicine, environmental performance of products and manufacturing and human rights. Further advantages of the invention include providing a cross-sectional technology spanning over several technical subjects including medicine and human rights. Further advantages of the invention include providing a secure, controlled and traceable system for allocating randomly generated codes to manufacturers and system user intermediaries so as to create a global, independent, auditable, standard system accessible in real time to authorized users.

Additional advantages provided by embodiments of the invention include providing a product passport providing, for any given product a unique, independent, auditable, easily accessible in real time, and user updatable audit trail providing to a user information on one or more of product manufacture, supply chain transit, ownership, purchase funding, and end of life status including one or more of consumption status, destruction status, and recycling status.

Further advantages provided by embodiments of the invention include allowing potential purchasers of a product, upon checking the product using the unique product passport, to learn regarding an individual product one or more of product components, component products, product ingredients, product sub-components, details regarding amount of labor needed to produce the product, ingredient or sub-component, cost of labor to produce the product, current product location, product location at a past time of interest, information on a location where the product was manufactured, information on identify of laborer(s) manufacturing the product, method of manufacture of the product, product source information, product content information, product manufacturing information, product transport information, a permissible end use condition, an actual end use condition, information on any other products into which the product has been integrated, and end of life information regarding one or more of consumption, recycling, disposal, and destruction of the product. The labor content may compel manufacturers to improve one or more of a labor standard, a factory condition, a quality of a chemical ingredient, and the like. Embodiments of the invention therefore have the potential to have an impact on other technology areas including one or more of medicine, an environmental impact of a product, and human rights.

Yet other advantages provided by embodiments of the invention include permitting a user to use the cumulation of the real-time product information comprised in product passports on the product information system to assess manufacturing capacity in production facilities. Still further advantages provided by embodiments of the invention include making it possible for the system user, using the real-time product information regarding manufacturing capacity regarding a product to more readily ascertain whether a product has untoward aspects including one or more of a stolen product, a defective vaccine, a problematic vaccine dose, likely damage to the product, a product subject to a finance charge, a product subject to a past back door sale, product content dilution, a corrupt medical product, and a product manufactured using one or more of unpermitted sub-contracting, slavery, and sweatshop conditions.

Still other advantages provided by embodiments of the invention include providing real-time product information to a system user that may assist the system user in determining a party that is one or more of capable to pay for a problem that has arisen in relation to the product and bears a duty to pay for the problem (including damage, delay, insurance payments, medical prescription charge payments and so on).

Yet additional advantages provided by embodiments of the invention include providing real-time information through the cumulation of the real-time product information comprised in product passports on the product information system regarding one or more of medical administration information of the product and real-time updated product use instructions in the system user's own language.

Further advantages provided by embodiments of the invention include offering system users the ability to update records in the product passport on the product information system about one or more of a product they purchase and use of the product.

Other advantages of embodiments of the invention include offering system users the ability to compare on the product information system one or more of a feature and functionality of the individual product, as opposed to generic information on the product.

Advantages of embodiments of the invention further include providing a system user with the ability to gain information in the product passport on the product information system regarding an product's status with regard to one or more of regulatory licensing, patent licensing, contractual licensing, compatibility with a language-related standard, compatibility with an electrical standard, compatibility with a communications standard, and compliance with a sanction.

Additional advantages provided by embodiments of the invention include providing a system user with the ability to obtain real-time product information in the product passport regarding a product so as to facilitate one or more of distribution of the product, redistribution of the product, and management of the supply chain for the product. Yet other advantages provided by embodiments of the invention include providing information in the product passport regarding a product to a system user to facilitate a response to one or more of a natural disaster affecting the supply chain of the product and another crisis affecting the supply chain of the product.

Yet other advantages provided by embodiments of the invention is providing a product information system and method for researching one or more of distribution and effectiveness of a medicine, evidence of supply of a medicine in breach of one or more of government sanctions and license terms, for product recalls, for understanding purchaser preferences for a product, and to optimize the supply chain.

Other advantages provided by embodiments of the invention include avoiding shortcomings of the prior art including one or more of a failure to identify an individual manufactured product, a failure to provide real-time access to product information regarding the product, and a failure to provide real-time analysis of product information by a system user. Further advantages provided by embodiments of the invention include avoiding a problem with prior art serialization-driven standards of a need to use many of the limited number of fields that are available within a bar code or QR code to address standard generic product information sets that relate to the individual product but that are not unique to it. Examples of such fields include one or more of country of origin, product size, generic product type, and the like. Additional advantages of embodiments of the invention include, relative to the prior art, providing a system allowing a virtually limitless number of non-repeatable product passports. Additional advantages include obviating the need to create systems capable of storing and enabling analysis of manufactured product by reference to the manufacturer's own unique serial numbering system

Further advantages of embodiments of the invention include providing one or more of independent, real-time information on an individual product and aggregated product information from outside of any individual manufacturer-controlled or organization-controlled supply chain. Yet other advantages of embodiments of the invention include overcoming the limitations of generic data recording and tracking that is present in current bar code and QR code-driven serialization systems while at the same time keeping the total number of fields within the product passport's unique alphanumeric code within total character field number limitations that apply to prior art bar code and data matrix technologies. Yet other embodiments of the invention accordingly offer the advantage of providing a unique product passport alphanumeric code for each individual product, thereby making. possible an individualized product passport and audit trail for a life of the product.

Yet additional advantages provided by embodiments of the invention include avoiding other problems of the existing prior art by allowing identification of individual manufactured products from the unique product passport, thereby substantially increasing utility. Further advantages provided by embodiments of the invention include providing information about the individual product using a system that is independent of the manufacturer and of all subsequent owners and possessors of the product.

A yet additional advantage of embodiments of the invention is that the random allocation of a unique product passport alphanumeric code to a system user helps eliminate a possibility of one or more of duplicative code creation and faked code creation, whether accidental or intentional. A still other advantage of embodiments of the invention is that association according to embodiments of the invention by the system user of the unique product passport with a single product information record regarding the product helps further eliminate a possibility of one or more of duplicative code creation and faked code creation, whether accidental or intentional.

A further advantage of embodiments of the invention is that none of the character fields in the product passport's unique alphanumeric code comprises a specific meaning such as a GS1 country code. A yet other advantage of embodiments of the invention is that accordingly, substantial efficiency is promoted, allowing more information to be stored by using the product passport's alphanumeric code as a means of connecting with product information in a database. Moreover, a still additional advantage of embodiments of the invention is that information relating to an individual product (and not just to a generic product type) can be stored on the product information system, and can then be one or more of easily accessed and easily updated.

A still other advantage of embodiments of the invention is that the system user who makes a request can use the product information system to access a product passport and to obtain in real time product information regarding one or more of a composition of the product, a location of the product, a present use of the product, a past use of the product, and an end of life status of the product.

While the above representative embodiments have been described with certain components in exemplary configurations, it will be understood by one of ordinary skill in the art that other representative embodiments can be implemented using different configurations and/or different components. For example, it will be understood by one of ordinary skill in the art that the order of certain steps and certain components can be altered without substantially impairing the functioning of the invention.

The representative embodiments and disclosed subject matter, which have been described in detail herein, have been presented by way of example and illustration and not by way of limitation. It will be understood by those skilled in the art that various changes may be made in the form and details of the described embodiments resulting in equivalent embodiments that remain within the scope of the invention. It is intended, therefore, that the subject matter in the above description shall be interpreted as illustrative and shall not be interpreted in a limiting sense.

1. A computer-implemented method of providing information about an individual product item, using a product information system comprising a product information server, the method comprising:
deciding, by the product information system, using the product information server, an application by a system applicant applying to register as a system user of the product information system;
creating, by the product information system, using the product information server, a product passport configured to provide item-specific product information regarding a unique individual product;
populating the product passport, by the product information system, using the product information server, with item-specific product information regarding the product;
receiving from a system user, by the product information system, using the product information server, a user request for item-specific product information regarding the product;
providing, by the product information system, using the product information server, the requested item-specific product information to the system user; and
recording, by the product information system, using the product information server, a product transaction involving the product.

2. The method of claim 1, wherein the product passport comprises an alphanumeric code that is unique to the individual product.

3. The method of claim 1, wherein the alphanumeric code comprises a non-sequential, randomly generated alphanumeric code.

4. The method of claim 1, wherein the alphanumeric code is configured to be one or more of directly applied to the product and applied to a label configured to be affixed to the product.

5. The method of claim 1, wherein the system user of the product has a relationship to the product comprising one or more of a grower, a collector, a harvester of materials, an extractor of materials, a manufacturer, an integrator of other manufactured products to make one or more of a bundle of products and a new product, a transporter, a repairer, a retailer, a wholesaler, an end user, and a disposer.

6. The method of claim 1, wherein the product information server is further configured to extract from the product passport item-specific information regarding that product.

7. The method of claim 5, wherein the product information server is further configured to extract from a product passport of a related product that is related to the product, product-related information regarding the product.

8. The method of claim 1, wherein the product information system, using the product passport, is configured to provide a real-time record of a life of the product.

9. The method of claim 8, wherein the real-time record begins at a time of creation of the product.

9. The method of claim 7, wherein the real-time record ends at an end of life of the product.

10. The method of claim 1, further comprising a step, performed after the populating step, of:
using the product information system, using the product information server, creating an auditable trail of one or more of product ownership and product location.

11. Second-hand sales of a product that is already registered with the product information server can also be registered through the product information server with one or more of the product passport's unique alphanumeric code and the system user's password preventing a thief from hacking in and changing details.

12. The method of claim 1, wherein the method further comprises an additional step, performed after the creating step and before the populating step, of:
associating the product passport's unique alphanumeric code with the individual product.

13. A product information system configured to do one or more of create a product passport, provide product information and verify product information regarding an individual product item, the system comprising:
a product information server configured to gather product information, the product information server further configured to do one or more of create a product passport, provide product information and verify product information, the product passport comprising one or more of product passport information and an alphanumeric code unique to the product;
a network usable by the product information server to gather the product information;
a system-participant-server operable connection configured to operably connect a system participant to the product information server via the network, the system participant comprising one or more of a system user and a third-party information source configured to provide information regarding the product, the system user comprising one or more of a manufacturer configured to contribute to creation of a product, a transporter configured to change a location of a product, a retailer configured to offer a product for sale, an end user configured to do one or more of use and consume a product, and a disposer configured to dispose of a product, wherein at least two of the system participants are operably connected to each other; and
a database configured to hold one or more of the product passport information and the product's unique alphanumeric code, the database operably connected to the product information server.

14. A computer-implemented method of providing information about an individual product item, using a product information system comprising a product information server, the method comprising:
receiving, by the product information system, using the product information server, system applicant information from a system applicant applying to register as a system user of the product information system;
validating, by the product information system, using the product information server, the received system applicant information;
deciding, by the product information system, using the product information server, to accept the received system applicant information;
obtaining, by the product information system, using the product information server, third-party system applicant information regarding the system applicant from a trusted third-party information source;
generating, by the product information system, using the product information server, system applicant comparison information usable to compare the system applicant with a comparable system participant;
overlaying, by the product information system, using the product information server, two or more of the system applicant information, the third-party system applicant information, and the system applicant comparison information;
validating the system applicant, by the product information system, using the product information server;
making, by the product information system, using the product information server, a system applicant decision using the overlay;
accepting the system applicant as a system user, by the product information system, using the product information server;
authenticating, by the product information system, using the product information server, the system user as a legitimate, known user of the product information system; and
notifying the system applicant, by the product information system, using the product information server, of the acceptance of the system applicant as a system user.

15. The method of claim 14, wherein the step of receiving the system applicant information comprises providing the system applicant, by the product information system, using the product information server, with a transmission method for transmitting to the product information server the system applicant information.

16. The method of claim 15, wherein the transmission method comprises uploading the product information from the system applicant using a prescribed electronic product information upload form.

17. The method of claim 16, wherein the system applicant information comprises one or more of a system applicant language and a system applicant location.

18. The method of claim 17, wherein the product information system, using the product information server, uses the system applicant location to determine one or more system applicant languages used in the system applicant location.

19. The method of claim 18, wherein the product information system, using the product information server, translates the product information into the system applicant language.

20. The method of claim 19, wherein the product information system, using the product information server, translates the upload form to the system applicant language.

21. The method of claim 14, wherein the step of making the system applicant decision comprises comparing two or more of the received system applicant information, the third-party system applicant information, and system applicant comparison information.

22. The method of claim 14, wherein the generating step comprises one or more of obtaining and locating.

23. The method of claim 22, wherein obtaining comprises obtaining from one or more of the trusted third-party source and a comparable system participant.

24. The method of claim 14, wherein the generating step comprises locating system applicant comparison information from system participant information relating to the comparable system participant and comprised in the product information system.

25. The method of claim 14, comprising an additional step, performed after the step of validating the received system applicant information and before the deciding step, of:
requesting, by the product information system, using the product information server, further system applicant information from the system applicant.

26. The method of claim 25, further comprising an additional step, performed after the requesting step and before the deciding step, of:
receiving, by the product information system, using the product information server, the requested further system applicant information from the system applicant.

27. The method of claim 26, further comprising an additional step, performed after the step of receiving the requested further system applicant information and before the deciding step, of:
validating, by the product information, system, using the product information server, the received further system applicant information.

28. The method of claim 23, wherein the comparable system participant comprises a system participant that shares with the system applicant one or more of a system applicant characteristic role, a system applicant corporate status, a system applicant corporate ownership, a system applicant physical location, a system applicant product type, a system applicant service type, a system applicant employee number, a system applicant revenue, a system applicant comparable product, a system applicant comparable service, a system applicant regulator standard compliance certification, a system applicant market, a system applicant licensed market, a system applicant language spoken, a system applicant sanction status, a system applicant financial rating, a system applicant product performance, a system applicant independent product rating, a system applicant service performance, a system applicant independent service rating, a system applicant product price, a system applicant service price, a system applicant corporate status, a system applicant ethical corporate status, a system applicant legal compliance record, a system applicant creditworthiness rating, and another comparable system applicant characteristic.

29. A computer-implemented method of providing information about an individual product item, using a product information system comprising a product information server, the method comprising:
receiving, by the product information system, using the product information server, a passport request for a product passport from a manufacturer of the product, the passport request comprising product information regarding the product;
creating a product passport for the product, by the product information system, using the product information server, the product passport comprising a unique alphanumeric code;
sending, by the product information system, using the product information server, the product passport to the manufacturer;
receiving a manufacturing code application update, by the product information system, using the product information server, the manufacturing code application update comprising an update advising the product information system that the manufacturer has applied the alphanumeric code to the product;
provisionally associating the product passport with the product, by the product information system, using the product information server;
receiving, by the product information system, using the product information server, further product information from a system user;
validating, by the product information system, using the product information server, the received further product information;
deciding, by the product information system, using the product information server, to accept the received further product information;
obtaining, by the product information system, using the product information server, third-party product information regarding the product from a trusted third-party information source;
generating, by the product information system, using the product information server, product comparison information usable to compare the product with a comparable product;
overlaying, by the product information system, using the product information server, two or more of the product information, the third-party product information, and the product comparison information;
validating the product, by the product information system, using the product information server;
making, by the product information system, using the product information server, a product decision using the overlay;
accepting the product, by the product information system, using the product information server;
authenticating, by the product information system, using the product information server, the product as a legitimate, known product on the product information system;
notifying the manufacturer, by the product information system, using the product information server, of acceptance of the product by the product information system;
associating the product passport with the product, by the product information system, using the product information server;
populating, by the product information system, using the product information server the product information into the product passport, thereby completing an initial product passport; and
storing, by the product information system, using the product information server, the product passport.

30. The method of claim 29, wherein the product information comprises one or more of a product type, a product system user language, and a product system user location.

31. The method of claim 30, wherein the product information system, using the product information server, uses the product system user location to determine one or more product system user languages used in the product system user location.

32. The method of claim 29, wherein the step of making the product decision comprises comparing two or more of the received product information, the third-party product information, and product comparison information.

33. The method of claim 29, wherein the generating step comprises one or more of obtaining and locating.

34. The method of claim 29, wherein generating comprises obtaining from one or more of the trusted third-party source and a comparable system participant.

35. The method of claim 29, wherein the generating step comprises locating product comparison information relating to the product and comprised in the product information system.

36. The method of claim 35, wherein the product comparison information is previously obtained from one or more of the trusted third-party source and the comparable system participant.

37. The method of claim 29, wherein the step of receiving the passport request comprises providing the manufacturer, by the product information system, using the product information server, with a transmission method for transmitting to the product information server the product information.

38. The method of claim 37, wherein the transmission method comprises uploading the product information from the manufacturer using a prescribed electronic product information upload form.

39. The method of claim 38, wherein the product information system, using the product information server, translates the upload form to the product system user language.

40. The method of claim 29, wherein the further product information comprises one or more of product basic information, product component information, product manufacture information, product comparison information, product untoward information, and product contextual information.

41. The method of claim 29, wherein the product untoward information comprises one or more of information regarding a stolen product, a defective vaccine, a problematic vaccine dose, likely damage to the product, a product subject to a finance charge, a product subject to a past back door sale, product content dilution, a corrupt medical product, and a product manufactured using one or more of unpermitted sub-contracting, slavery, and sweatshop conditions.

42. The method of claim 29, wherein the associating step comprises applying the product passport's unique alphanumeric code to the product to which it is being associated.

43. A computer-implemented method of providing information about an individual product item, using a product information system comprising a product information server, the method comprising:
associating, by the product information system, using the product information server, with an individual product item at a time of its manufacture, a unique product passport comprising its own unique alphanumeric code;
receiving, by the product information system, using the product information server, from a system user, a user request for item-specific product information regarding the product;
extracting, by the product information system, using the product information server, from the product passport, the requested item-specific information;
extracting, by the product information system, using the product information server, product-related information from a related product item product passport of a related product item;
obtaining, by the product information server, from the product information system, user-requested product information; and
presenting, by the product information system, using the product information server, the requested product information to the system user.

44. The method of claim 43, wherein the user request further comprises one or more of a user language and a user location.

45. The method of claim 44, wherein the product information system, using the product information server, uses the user location to determine one or more user languages used in the user location.

46. The method of claim 45, comprising an additional step, performed after the obtaining step and before the presenting step, of:
translating, by the product information system, using the product information server, the requested product information into the user language.

47. A computer-implemented method of providing information about an individual product item, using a product information system comprising a product information server, the method comprising:
receiving, by the product information system, using the product information server, from a first system user, first system user information comprising first system user identifying information identifying the first system user, the first system user information further comprising first system user product relationship information regarding a relationship of the first system user to the product, the first system user information further comprising first system user transaction information identifying a desired transaction of the first system user with a product, the desired transaction intended to transfer the product from the first system user to a second system user, the first system user transaction information further comprising the product's unique alphanumeric code;
recording, by the product information system, using the product information server, the relationship of the first system user to the product;
recording, by the product information system, using the product information server, the first system user transaction information;
receiving, by the product information system, using the product information server, from the second system user, second system user information comprising second system user identifying information identifying the second system user, the second system user information further comprising second system user product relationship information regarding a relationship of the second system user to the product, the second system user information further indicating that the second system user is completing the desired transaction, the second system user information further comprising the product's unique alphanumeric code;
receiving, by the product information system, using the product information server, transaction information confirming completion of the desired transaction;
validating, by the product information system, using the product information server, the received transaction information;
recording by the product information system, using the product information server, a change of ownership of the product from the first system user to the second system user; and
updating, by the product information system, using the product information server, a product possession record comprised in the product passport.

48. The method of claim 47, wherein the transaction comprises one or more of a past transaction, an ongoing transaction, and a desired transaction.

49. The method of claim 47, wherein the transaction comprises one or more of a logistics transaction, a product integration transaction, a product repair, a product sale, a product lease, a product loan, and a product disposal.

50. The method of claim 49, wherein disposal comprises one or more of consumption, recycling, and destruction.

51. The method of claim 47, wherein ownership comprises possession.

52. The method of claim 47, wherein the first system user comprises a seller of the product.

53. The method of claim 47, wherein the second system user comprises a purchaser of the product.

54. The method of claim 47, wherein the validating step comprises validating the received transaction information by comparing the received transaction information with product comparison information.

55. The method of claim 47, wherein the product comparison information comprises product information that the product information server has received from a system participant associated with the product.

56. The method of claim 47, wherein the validating step comprises checking for one or more of product information entry by the manufacturer, location of the transaction, the transaction price, lack of fraud in the transaction, a proper product supply chain, correctness of a transaction, a correct first system user, a correct second system user, release of the finance charge to which the product is subject, transaction authorization for the transaction of the first system user, and transaction authorization for the transaction of the second system user.

57. The method of claim 56, wherein the system prohibits the transaction authorization because of one or more of the first system user's age, the first system user's lack of a required permit, the first system user being subject to a sanction, the first system user lacking a needed license for sale of a restricted product, and another prohibition reason.

58. The method of claim 56, wherein the system prohibits the transaction authorization because of one or more of the second system user's age, the second system user's lack of a required permit, the second system user being subject to a sanction, the second system user lacking a needed license for purchase of a restricted product, and another prohibition reason.

59. The method of claim 47, wherein the product information system does not require the second system user to be registered as an authorized system user.

60. The method of claim 47, wherein the step of recording the change of ownership comprises a sub-step of:
receiving product comparison information from a system participant associated with the product.

61. The method of claim 60, further comprising an additional sub-step, performed after the sub-step of receiving the product comparison information, of comparing the received transaction information with the product comparison information.

62. The method of claim 61, further comprising an additional sub-step, performed after the comparing sub-step, of:
determining if agreement between the received transaction information and the product comparison information is sufficient.

63. The method of claim 47, wherein the step of updating the product possession record reflects the transaction.

64. The method of claim 47, wherein the step of updating the product passport reflects the transaction.

65. A computer-implemented method of providing information about an individual product item, using a product information system comprising a product information server, the method comprising:
receiving, by the product information system, using the product information server, system applicant information from a system applicant applying to register as a system user of the product information system;
validating, by the product information system, using the product information server, the received system applicant information;
deciding, by the product information system, using the product information server, to accept the received system applicant information;
obtaining, by the product information system, using the product information server, third-party system applicant information regarding the system applicant from a trusted third-party information source;
generating, by the product information system, using the product information server, system applicant comparison information usable to compare the system applicant with a comparable system user;
overlaying, by the product information system, using the product information server, two or more of the system applicant information, the third-party system applicant information, and the system applicant comparison information;
validating the system applicant, by the product information system, using the product information server;
making, by the product information system, using the product information server, a system applicant decision using the overlay;
accepting the system applicant as a system user, by the product information system, using the product information server;
authenticating, by the product information system, using the product information server, the system user as a legitimate, known user of the product information system;
notifying the system applicant, by the product information system, using the product information server, of the acceptance of the system applicant as a system user;
receiving, by the product information system, using the product information server, a passport request for a product passport from a manufacturer of the product, the passport request comprising product information regarding the product;
creating a product passport for the product, by the product information system, using the product information server, the product passport comprising a unique alphanumeric code;
sending, by the product information system, using the product information server, the product passport to the manufacturer;
receiving a manufacturing code application update, by the product information system, using the product information server, the manufacturing code application update comprising an update advising the product information system that the manufacturer has applied the alphanumeric code to the product;
provisionally associating the product passport with the product, by the product information system, using the product information server;
receiving, by the product information system, using the product information server, further product information from a system user;
validating, by the product information system, using the product information server, the received further product information;
deciding, by the product information system, using the product information server, to accept the received further product information;
obtaining, by the product information system, using the product information server, third-party product information regarding the product from a trusted third-party information source;
generating, by the product information system, using the product information server, product comparison information usable to compare the product with a comparable product;
overlaying, by the product information system, using the product information server, two or more of the product information, the third-party product information, and the product comparison information;
validating the product, by the product information system, using the product information server;
making, by the product information system, using the product information server, a product decision using the overlay;
accepting the product, by the product information system, using the product information server;
authenticating, by the product information system, using the product information server, the product as a legitimate, known product on the product information system;
notifying the manufacturer, by the product information system, using the product information server, of acceptance of the product by the product information system;
associating the product passport with the product, by the product information system, using the product information server;
populating, by the product information system, using the product information server, the product information into the product passport, thereby completing an initial product passport;
storing, by the product information system, using the product information server, the product passport;
receiving, by the product information system, using the product information server, from a system user, a user request for item-specific product information regarding the product;
extracting, by the product information system, using the product information server, from the product passport, the requested item-specific information;
extracting, by the product information system, using the product information server, product-related information from a related product item product passport of a related product item;
obtaining, by the product information server, from the product information system, user-requested product information;
presenting, by the product information system, using the product information server, the requested product information to the system user;
receiving, by the product information system, using the product information server, from a first system user, first system user information comprising first system user identifying information identifying the first system user, the first system user information further comprising first system user product relationship information regarding a relationship of the first system user to the product, the first system user information further comprising first system user transaction information identifying a desired transaction of the first system user with a product, the desired transaction intended to transfer the product from the first system user to a second system user, the first system user transaction information further comprising the product's unique alphanumeric code;
recording, by the product information system, using the product information server, the relationship of the first system user to the product;
recording, by the product information system, using the product information server, the first system user transaction information;
receiving, by the product information system, using the product information server, from the second system user, second system user information comprising second system user identifying information identifying the second system user, the second system user information further comprising second system user product relationship information regarding a relationship of the second system user to the product, the second system user information further indicating that the second system user is completing the desired transaction, the second system user information further comprising the product's unique alphanumeric code;
receiving, by the product information system, using the product information server, transaction information confirming completion of the desired transaction;
validating, by the product information system, using the product information server, the received transaction information;
recording by the product information system, using the product information server, a change of ownership of the product from the first system user to the second system user; and
updating, by the product information system, using the product information server, a product possession record comprised in the product passport.

66. A computer-implemented method of providing information about an individual product item, using a product information system comprising a product information server, the method comprising:
recording, by the product information system, using the product information server, an acceptance of a system applicant as a system user;
recording, by the product information system, using the product information server, a passport request regarding a product from the system user;
recording creation, by the product information system, using the product information server, of a product passport for the product, the product passport comprising a unique alphanumeric code;
recording product manufacture information received from the manufacturer, by the product information system, using the product information server, regarding manufacturing of the product;
recording, by the product information system, using the product information server, acceptance of the product by the product information system;
recording, by the product information system, using the product information server, transaction information regarding a completed transaction changing one or more of the product ownership and the product location; and
recording by the product information system, using the product information server, the change of one or more of the product ownership and the product location.

67. The method of claim 66, wherein the step of recording the acceptance of the system applicant as a system user comprises recording one or more of product ownership and product location.

68. The method of claim 66, wherein the step of recording the acceptance of the system applicant as a system user comprises recording both product ownership and product location.

69. The method of claim 66, wherein the step of recording the acceptance of the system applicant as a system user comprises recording the acceptance of the system applicant as the system user, by the product information system, using the product information server, in the product passport.

70. A computer-implemented method of providing information about an individual product item, using a product information system comprising a product information server, the method comprising:
generating, by the product information system, using the product information server, a product passport for a unique individual product;
hosting, by the product information system, using the product information server, the product passport on the product information system;
converting, by the product information system, using the product information server, the product passport's unique alphanumeric code into a machine readable form;
applying by the product information system, using the product information server, the product passport's unique alphanumeric code to the product to which it is being associated;
receiving, by the product information system, using the product information server, from a manufacturer of the product, product manufacture information relating to manufacture of the product;
associating, by the product information system, using the product information server, the product passport with the product;
associating, by the product information system, using the product information server, the product manufacture information with the product passport;
receiving, by the product information system, using the product information server, a request for the product passport from a registered system user within a supply chain of the product; and
transmitting, by the product information system, using the product information server, the requested product passport alphanumeric code to the system user.
